(19) United States
(12) Patent Application Publication
(10) Pub. No.: US 2026/0155741 A1
(43) Pub. Date: Jun. 4, 2026

(54) VOLTAGE REGULATOR MODULE, CONTROL METHOD, INTELLIGENT POWER MODULE ARRANGEMENT, AND PIN ARRANGEMENT

(71) Applicant: MetaPWR Electronics Co., Ltd., Shanghai (CN)

(72) Inventors: Da Jin, Shanghai (CN); Mingzhun ZHANG, Shanghai (CN); Xiaoni Xin, Shanghai (CN); Yahong Xiong, Shanghai (CN); Jianhong ZENG, Shanghai (CN)

(73) Assignee: MetaPWR Electronics Co., Ltd., Shanghai (CN)

(21) Appl. No.: 19/405,406

(22) Filed: Dec. 2, 2025

(30) Foreign Application Priority Data
Dec. 2, 2024 (CN) 202411749806.0
Dec. 25, 2024 (CN) 202411923736.6
Jan. 22, 2025 (CN) 202510098160.2
Apr. 3, 2025 (CN) 202510420044.8

(51) Int. Cl. H02M 3/00; H01F 27/24; H01F 27/28

(52) U.S. Cl. CPC H02M 3/003; H01F 27/24; H01F 27/28

(57) ABSTRACT

The present application provides a module structure with high efficiency and good heat dissipation performance, which improves the heat dissipation capability of the VRM module by means of the design of the self-contained heat sink, so as to improve the output power of the VRM module; by means of the device placement in the VRM module, the parasitic parameters on the power transmission path are reduced, and the conversion efficiency of the VRM module is improved; and the dynamic performance of the VRM module is further improved by means of the TLVR technology.

### CROSS-REFERENCE TO RELATED APPLICATION

This application claims the priority benefit of China application serial no. CN202411749806.0, filed on Dec. 2, 2024, China application serial no. 202411923736.6, filed on Dec. 25, 2024, China application serial no. 202510098160.2, filed on Jan. 22, 2025, and China application serial no. 202510420044.8, filed on Apr. 3, 2025. The entirety of each of the above-mentioned patent applications is hereby incorporated by reference herein and made a part of this specification.

### BACKGROUND

### Technical Field

The present application provides a VRM with a low parasitic parameter, a self-contained heat sink and a high conversion efficiency for the dynamic performance and steady-state efficiency of the output voltage required by the high-power VRM, and can also implement TLVR technology.

### Description of Related Art

In recent years, with the development of technologies such as data center, artificial intelligence, and supercomputers, more and more powerful ASICs are used to obtain applications, such as CPU, GPU, TPU, NPU, ML, AI accelerator, network switch, server, etc. which consume a large amount of current, such as thousands of amperes; and these ASICs have higher and higher dynamic response requirements for power supply. A multi-phase voltage regulator module (VRM-Voltage Regulator Module) is traditionally used to supply such a load. With the advancement of the semiconductor technology, the power supply power of the ASIC is further increased, and the power supply voltage required by the ASIC is lower and lower, and therefore, the power supply current of the ASIC continues to increase; as the ASIC power supply current increases, the output power and the output current of the VRM also increase; the improvement of the VRM conversion efficiency and the improvement of the heat dissipation capability become a key to improve VRM power.

As the current continues to increase, the requirements of the ASIC for the dynamic performance of the VRM are getting higher and higher; the anti-coupling inductor technology has a relatively low leakage inductance, and therefore has a relatively fast transient response; moreover, the anti-coupling inductor has a relatively high steady-state equivalent inductance, which is beneficial to the improvement of efficiency; that is, the anti-coupling inductor technology can meet the requirements of transient performance, and can also take into account the improvement of efficiency. Therefore, the anti-coupling inductor technology is a hot spot designed by a VRM. However, a Trans-inductor voltage regulator (hereinafter referred to as TLVR) technology having the same technical effect can realize coupling of multiple mutually independent inductors that have no coupling relationship with each other by adding auxiliary windings; the dynamic response performance of the reverse coupling inductor technology can also be achieved; therefore, it is also a design hotspot in this field.

### SUMMARY

In view of the above, one of the objectives of the application is to provide a voltage regulator module, comprising a top assembly and a middle assembly; the top assembly comprises a top substrate, N intelligent power modules and metal blocks, N being a natural number greater than 1; the top substrate comprises a top surface and a bottom surface opposite to each other, the intelligent power modules are disposed on the bottom surface of the top substrate or embedded in the top substrate, and the metal blocks are disposed on the top surface of the top substrate; the intelligent power module comprises a top surface and a bottom surface opposite to each other, and the top surface of the intelligent power module is electrically connected to the top substrate; the middle assembly is disposed adjacent to the bottom surface of the top substrate and is electrically connected to the intelligent power module.

Preferably, wherein the middle assembly comprises a top surface and a bottom surface opposite to each other, a magnetic core, a winding and an electrical connector, the magnetic core comprises a first side surface and a third side surface opposite to each other, a second side surface and a fourth side surface opposite to each other, and a top surface and a bottom surface opposite to each other, a first end of the winding is electrically connected to the bottom surface of the intelligent power module, the electrical connector is disposed on the side surface of the magnetic core, and the electrical connector is electrically connected to the metal block by means of the top substrate.

Preferably, wherein the electrical connector comprises a first power electrical connector and a second power electrical connector, the metal block comprises a first metal block and a second metal block, the first power electrical connector is electrically connected to the first metal block, and the second power electrical connector is electrically connected to the second metal block.

Preferably, wherein the intelligent power module comprises a high-side power switch and a low-side power switch, the high-side power switch and the low-side power switch are both vertical power switches, and the high-side power switch and the low-side power switch are electrically connected in series.

Preferably, wherein a drain of the high-side power switch and a source of the low-side power switch are both disposed on a top surface of the vertical switch, a source of the high-side power switch and a drain of the low-side power switch are both disposed on a bottom surface of the vertical switch, and the source of the high-side power switch and the drain of the low-side power switch are electrically connected in series to the SW terminal.

Preferably, wherein the electrical connector comprises a first power electrical connector and a second power electrical connector, the drain of the high-side power switch is electrically connected to the first power electrical connector, the source of the low-side power switch is electrically connected to the second power electrical connector, and the first end of the winding is electrically connected to the SW terminal.

Preferably, further comprising a bottom assembly, wherein the bottom assembly comprises a bottom substrate, the bottom substrate comprises a top surface and a bottom surface opposite to each other and a pin, a second end of the winding and the electrical connector are both electrically connected to the pin of a top surface of the bottom substrate, and the bottom surface of the bottom substrate is electrically connected to an external load.

Preferably, wherein the middle assembly further comprises a signal electrical connector, the signal electrical connector is electrically connected to the intelligent power module, and the signal electrical connector is disposed on the side surface of the magnetic core.

Preferably, wherein the first power electrical connector is disposed on the first side surface and the third side surface of the magnetic core, and the second power electrical connector is disposed on the second side surface and the fourth side surface of the magnetic core.

Preferably, wherein the first power electrical connector and the second power electrical connector are both disposed on the second side surface and the fourth side surface of the magnetic core, and the first power electrical connector is located on two sides of the second power electrical connector.

Preferably, wherein the metal block comprises at least two first metal blocks and at least one second metal block, the second metal block is arranged between the first metal blocks, the top assembly further comprises an input capacitor, the input capacitor is arranged between the first metal block and the second metal block, the first metal block, the second metal block and the input capacitor are sequentially arranged according to the order of the first metal block, the input capacitor, the second metal block, the input capacitor and the first metal block.

Preferably, wherein the bottom surface of the top assembly is provided with a pin, the pin comprises an input pin VIN, a ground pin GND, and a switch middle pin SW, the metal block comprises a first metal block and a second metal block, the electrical connector comprises a first power electrical connector and a second power electrical connector, the input pin VIN is electrically connected to the first metal block and the first power electrical connector, the ground pin GND is electrically connected to the second metal block and the second power electrical connector, and the switch middle pin SW is electrically connected to the bottom surface of the intelligent power module.

Preferably, wherein the top assembly further comprises a metal column disposed on the bottom surface of the top substrate, the intelligent power module and the metal column are molded together by a plastic packaging material, the metal column is electrically connected to the metal block by means of the top substrate, the pin is provided on a surface of the plastic packaging material, and the pin is electrically connected to the winding and the electrical connector.

Preferably, wherein the pin is arranged on the bottom surface of the top substrate, and the pin of the bottom surface of the top substrate is electrically connected to the metal block and the intelligent power module by means of a wiring or a metal column.

Preferably, wherein the pin of the bottom surface of the top assembly further comprises a signal pin, the middle component further comprises a signal electrical connector, and the signal pin is electrically connected to the signal electrical connector and the intelligent power module.

Preferably, wherein the signal electrical connector is a vertical plate structure.

Preferably, wherein the signal pin is realized by drilling and electroplating.

Preferably, wherein the N intelligent power modules are arranged in an array, wherein the low-side power switch of the N intelligent power modules are disposed adjacent to each other, the high-side power switch of each intelligent power module is disposed adjacent to the corresponding low-side power switch, and the switches of the intelligent power modules located in the same row are arranged in a sequence of the high-side power switch, the low-side power switch, the low-side power switch, and the high-side power switch.

Preferably, wherein the intelligent power module further comprises a driving/logic circuit, and the driving/logic circuit and the high-side power switch are arranged in parallel and are all arranged on the same outer side of the low-side power switch.

Preferably, wherein the winding comprises a main winding and an auxiliary winding, the electrical connector comprises a first power electrical connector, a second power electrical connector and an auxiliary winding electrical connector, the main winding and the auxiliary winding are coupled to each other, the first power electrical connector and the second power electrical connector are electrically connected to the top surface of the intelligent power module by means of the top substrate, and the bottom surface of the intelligent power module is electrically connected to the main winding.

Preferably, wherein the first power electrical connector is disposed on the first side surface and the third side surface of the magnetic core, the second power electrical connector and the auxiliary winding electrical connector are both disposed on the second side surface and the fourth side surface of the magnetic core, and the auxiliary winding electrical connector and the second power electrical connector are alternately disposed.

Preferably, further comprising a bottom assembly, wherein the bottom assembly comprises a bottom substrate, the bottom substrate comprises a top surface and a bottom surface opposite to each other and a pin, wherein the pin is disposed on the top surface and the bottom surface of the substrate; the first power electrical connector, the second power electrical connector, the main winding and the auxiliary winding electrical connector are all electrically connected to the pin of the top surface of the bottom substrate, and the auxiliary winding is connected in series by means of the auxiliary winding electrical connector, the top substrate and the bottom substrate to form an auxiliary winding loop, and the bottom surface of the bottom component is electrically connected to an external load.

Preferably, wherein the pin of the top surface of the bottom substrate comprises a first power pin, a second power pin and an output pin, the output pin is located in the middle of the bottom substrate or adjacent to the first side surface of the magnetic core, the first power pin and the second power pin surround the periphery or three side edges of the output pin, the first power pin is disposed adjacent to the first side surface and/or the third side surface of the magnetic core, the second power pin is disposed adjacent to the second side surface and the fourth side surface of the magnetic core, and the first power pin is disposed adjacent to the second power pin.

Preferably, wherein the output pin comprises two first output pins and two second output pins, the four output pins are arranged in a 2*2 array, the two first output pins are arranged close to the second side surface of the magnetic core, and the two second output pins are arranged close to the fourth side surface of the magnetic core.

Preferably, wherein there are three second power pins sequentially disposed on three side edges of the output pin, the first power pin is disposed on the fourth side edge of the output pin, and the three second power pins are electrically connected in sequence.

Preferably, wherein the output pin comprises a first output pin and a second output pin, and both output pins are in rectangular shape.

Preferably, wherein the pin of the top surface of the bottom substrate comprises a signal pin, and the signal pin is disposed adjacent to the first side surface and/or the third side surface of the magnetic core.

Preferably, wherein the pin of the top surface of the bottom substrate comprises a TLG extension pin and a TLC extension pin, and the TLG extension pin and the TLC extension pin are respectively arranged adjacent to a corner of the first side surface close to the second side surface of the magnetic core and a corner of the first side surface close to the fourth side surface of the magnetic core.

Preferably, wherein the pin of the bottom surface of the bottom substrate comprises an output pin, a first power pin and a second power pin, the output pin is arranged in the middle of the bottom surface of the bottom substrate, the first power pin and the second power pin are arranged around the output pin, and the first power pin and the second power pin are arranged adjacent to each other.

Preferably, wherein the pin of the bottom surface of the bottom substrate further comprises a signal pin, and the signal pin is disposed adjacent to the first side surface and/or the third side surface of the magnetic core and located outside the first power pin.

Preferably, wherein the pin of the bottom surface of the bottom substrate further comprises a TLG expansion pin and a TLC expansion pin, and the TLG extension pin and the TLC extension pin are provided at positions of two or four corners of the bottom surface of the substrate.

Preferably, wherein the pin of the bottom surface of the bottom substrate comprises an output pin, a first power pin and a second power pin, the output pin, the first power pin and the second power pin are sequentially arranged in the same direction as the sequence of the first power pin, the output pin, the second power pin, the output pin and the first power pin, the pin of the bottom substrate further comprises a signal pin, the signal pin is arranged adjacent to the first side surface and/or the third side surface of the magnetic core, and part of the signal pin is a TLG extension pin and a TLC extension pin.

Preferably, wherein the pin of the bottom surface of the bottom substrate is m*n LGA pins, where m and n are both integers greater than or equal to 1.

Preferably, wherein the pins of the bottom surface of the bottom substrate comprise a first power pin, a second power pin and an output pin, the first power pin, the second power pin, and the output pin are divided into two columns, and each column is arranged according to the sequence of the first power pin, the second power pin, the output pin, the second power pin, and the first power pin; a signal pin, a TLG extension pin, a TLC expansion pin and an auxiliary output pin are also arranged around the two columns of pins, the auxiliary output pin is respectively arranged adjacent to the second side surface and the fourth side surface of the magnetic core, the TLG extension pin is arranged between the auxiliary output pins adjacent to the second side surface the TLC extension pin is arranged between the auxiliary output pins adjacent to the fourth side edge, and the signal pins are arranged on the first side surface and the third side surface of the magnetic core.

Preferably, wherein the pin of the bottom surface of the bottom substrate adopts a pin array or a BGA array, the pin of the bottom surface of the bottom substrate includes an output pin, a first power pin, a second power pin, a signal pin, a TLG extension pin and a TLC extension pin, the output pin is arranged in an array of m*n pins, m and n are natural numbers greater than 1, and are located in a central region of the bottom substrate, the second power pin is arranged in two columns along the second side surface and the fourth side surface of the magnetic core respectively, the first power pin is arranged in two rows along the first side surface of the magnetic core, the TLG extension pin and the TLC extension pin are arranged adjacent to the first side surface of the magnetic core and are respectively located between the first power pin and the second power pin, and the signal pin is arranged along the third side surface of the magnetic core.

Preferably, wherein the bottom surface of the top substrate is provided with other passive elements, the top surface of the magnetic core is provided with a groove, and the groove is used for accommodating the other passive elements.

Preferably, wherein the top assembly further comprises a driving/logic circuit, one driving/logic circuit simultaneously controls two intelligent power modules, the driving/logic circuit is disposed between the two intelligent power modules, or the driving/logic circuit is disposed on a same side of two low-side power switches of the two intelligent power modules, the low-side power switches of the adjacent intelligent power modules are disposed adjacent to each other, and the high-side power switch is disposed on an outer side of the low-side power switch.

Preferably, further comprising N driving/logic circuits, each driving/logic circuit, each high-side power switch and each low-side power switch form a sub-unit, the driving/logic circuit and the high-side power switch are arranged side by side on one side of the low-side power switch, and the low-side power switches of the N sub-units are arranged adjacent to each other.

Preferably, further comprising N driving/logic circuits, each driving/logic circuit, each high-side power switch and each low-side power switch form a sub-unit, the driving/logic circuit and the high-side power switch are arranged side by side on one side of the low-side power switch, each of the sub-units coincides with its adjacent sub-unit by rotating clockwise or counterclockwise by a certain angle.

Preferably, wherein the bottom surface of the top substrate is provided with an input pin VIN, a ground pin GND, a switch middle pin SW, an auxiliary winding pin and an auxiliary winding electrical connector pin, the position of the switch middle pin SW is in one-to-one correspondence with the position of the main winding of the middle assembly and the switch middle pin SW is electrically connected with the main winding; the position of the auxiliary winding pin is in one-to-one correspondence with the position of the auxiliary winding and the auxiliary winding pin is electrically connected with the auxiliary winding; the position of the auxiliary winding electrical connector pin is in one-to-one correspondence with the position of the auxiliary winding electrical connector and the auxiliary winding electrical connector pin is electrically connected with the auxiliary winding electrical connector; the position of the input pin VIN is in one-to-one correspondence with the position of the first power electrical connector and the input pin is electrically connected with the first power electrical connector; and the position of the ground pin GND is in one-to-one correspondence with the position of the second power electrical connector and the ground pin GND is electrically connected with the second power electrical connector.

Preferably, wherein the bottom surface of the top substrate is further provided with a first signal pin and a second signal pin, the electrical connector further comprises a first signal electrical connector and a second signal electrical connector; the positions of the first signal pin and the first signal electrical connector are in one-to-one correspondence and the first signal pin is electrically connected to the first signal electrical connector; the positions of the second signal pin and the second signal electrical connector are in one-to-one correspondence and the second signal pin is electrically connected to the second signal electrical connector.

Preferably, wherein the first signal electrical connector is a vertical plate structure and is disposed adjacent to on the third side surface of the magnetic core, the second signal electrical connector is disposed adjacent to the first side surface and the third side surface of the magnetic core, respectively, and the second signal electrical connector is electronically connected to a TLG expansion pin and a TLC expansion pin.

Preferably, wherein the metal block comprises a plurality of first metal blocks and a plurality of second metal blocks, each of the first metal blocks is electrically connected to the drain of one high-side power switch respectively, and each of the second metal blocks is electrically connected to the source of two adjacent low-side power switches, respectively.

Preferably, the N low-side power switches are disposed adjacent to each other, and the top assembly further comprises input capacitor, the input capacitor is arranged among the second metal blocks and the central position of the N low-side power switches.

Preferably, wherein in the top substrate or on the bottom surface of the top substrate is provided with a high-frequency capacitor, and the high-frequency capacitor is disposed adjacent to the intelligent power module.

Preferably, wherein the high-efficiency power supply module comprises an input positive terminal, an input negative terminal, an output positive terminal and an output negative terminal, and the input negative terminal and the output negative terminal are short-circuited to the GND terminal; the first metal block is electrically connected to the positive terminal, and the second metal block is electrically connected to the GND terminal.

One of the objectives of the application is to provide a 4-phase VRM control method, comprising four Buck circuits; and the four Buck circuits are electrically connected in parallel; further comprising a first control signal PWM1, a second control signal PWM2, a first current detection signal, a second current detection signal, a first control logic circuit, a second control logic circuit, and a multiphase controller; the first control signal PWM1 and the second control signal PWM2 have the same period and are 180° out of phase; two drive signals are generated by the first control signal PWM1 by means of the first control logic circuit, the periods of the two drive signals are both twice the period of the first control signal PWM1, the two drive signals respectively drives two Buck circuits; a first summed current detection signal is generated by the first current detection signal by means of a first control logic circuit; the frequency and phase of the first summed current detection signal are the same as the first control signal PWM1, and the first control signal PWM1 and the first summed current detection signal are respectively connected to a control signal pin and a current detection signal pin of the same phase of the multiphase controller; two drive signals are generated by the second control signal PWM2 by means of the second control logic circuit, the two drive signals respectively drive the other two Buck circuits, the period of the two drive signals is twice the second control signal PWM2; a second summed current detection signal is generated by the second current detection signal by means of the second control logic circuit, the frequency and phase of the second summed current detection signal are the same as the second control signal PWM2, and the second control signal PWM2 and the second summed current detection signal are respectively connected to the control signal pin and the current detection signal pin of the same phase of the multiphase controller.

One of the objectives of the application is to provide a voltage regulator module, comprising a top assembly and a middle assembly, wherein the top assembly comprises a top substrate, an input positive pin, a ground pin and an intelligent power module, the middle assembly comprises a magnetic core, a winding and an electrical connector, the intelligent power module is arranged on a bottom surface of the top substrate or embedded in the top substrate, the input positive pin and the ground pin are arranged on the top surface of the top substrate, a top surface of the intelligent power module is electrically connected to the input positive pin and the ground pin by means of the top substrate, a bottom surface of the intelligent power module is electrically connected to a first end of the winding, a second end of the winding is electrically connected to an external load, the first end of the winding is arranged on the top surface of the middle assembly, and the second end of the winding is arranged on the bottom surface of the middle assembly; the electrical connector includes a power electrical connector disposed on a side surface of the magnetic core, and the power electrical connector is electrically connected to the ground pin.

Preferably, wherein the top assembly further comprises multiple metal blocks disposed on the top surface of the top substrate and the metal blocks are electrically connected to the input positive pin and the ground pin respectively.

Preferably, wherein the top assembly further comprises an input capacitor, and the input capacitor is connected across the input positive pin and the ground pin.

Preferably, wherein the intelligent power module comprises a high-side power switch and a low-side power switch, the high-side power switch and the low-side power switch are both vertical switches, the drain of the high-side power switch and the source of the low-side power switch are disposed on the top surface of the vertical switch, the source of the high-side power switch and the drain of the low-side power switch are disposed on the bottom surface of the vertical switch and are shorted to the switch middle end SW, the drain of the high-side power switch is disposed adjacent to the input positive pin and is electrically connected to the input positive pin, the source of the low-side power switch is disposed adjacent to the ground pin and is electrically connected to the ground pin, and the switch middle end SW is disposed adjacent to the winding and is electrically connected to the first end of the winding.

Preferably, further comprising a bottom assembly; a bottom surface of the bottom assembly is provided with an output pin and a power pin; the output pin is electrically connected to the second end of the winding; the power pin is electrically connected to the power electrical connector; and the output pin and the power pin form an output terminal of the voltage regulator module.

One of the objectives of the application is to provide an intelligent power module layout, wherein the intelligent power module layout comprises a plurality of intelligent power modules, and each intelligent power module comprises a high-side power switch and a low-side power switch; the high-side power switch and the low-side power switch are electrically connected in series; the plurality of low-side power switches are arranged adjacent to each other; the plurality of high-side power switches are arranged at the periphery of the plurality of low-side power switches and are respectively arranged adjacent to the corresponding low-side power switches; the plurality of intelligent power modules are arranged symmetrically along a symmetric axis, or in a windmill shape.

Preferably, wherein both the high-side power switch and the low-side power switch are vertical power switches, the drain of the high-side power switch and the source of the low-side power switch are both disposed on a top surface of the vertical switch, the source of the high-side power switch and the drain of the low-side power switch are both disposed on a bottom surface of the vertical switch, and the source of the high-side power switch and the drain of the low-side power switch are electrically connected in series to a SW terminal.

Preferably, wherein the switches in the intelligent power module of the same row are arranged in a sequence of a high-side power switch, a low-side power switch, a low-side power switch, and a high-side power switch.

Preferably, wherein each of the intelligent power modules further comprises a driving/logic circuit, and the driving/logic circuit and the high-side power switch are arranged side by side and are both arranged on the same outer side of the low-side power switch.

Preferably, further comprising at least one driving/logic circuit, wherein one driving/logic circuit simultaneously controls two intelligent power modules, the driving/logic circuit is disposed between two intelligent power modules, or the driving/logic circuit is disposed on the same side of two low-side power switches of the two intelligent power modules.

Preferably, wherein each of the intelligent power modules further comprises a driving/logic circuit, the driving/logic circuit and the high-side power switch are arranged side by side on one side of the low-side power switch, and each intelligent power module coincides with its adjacent intelligent power module after rotating clockwise or counterclockwise by a certain angle.

One of the objectives of the application is to provide a pin arrangement of a voltage regulator module, wherein the voltage regulator module comprises an intelligent power module and a middle assembly; the voltage regulator module further comprises a top surface and a bottom surface opposite to each other, a first side surface and a third side surface opposite to each other, and a second side surface and a fourth side surface opposite to each other; the middle assembly comprises a magnetic core and a winding; the intelligent power module is electrically connected to one end of the winding; the pins are arranged on the bottom surface of the voltage regulator module; the pin comprises an output pin, a first power pin and a second power pin; the output pin is arranged in the middle of the bottom surface of the voltage regulator module, and the first power pin and the second power pin are arranged around the output pin; the output pin is electrically connected to the other end of the winding, and the first power pin and the second power pin are electrically connected to the intelligent power module.

Preferably, wherein the first power pin is disposed adjacent to the first side surface and/or the third side surface of the voltage regulator module; the second power pin is disposed adjacent to the second side surface and/or the fourth side surface of the voltage regulator module; and further comprises a signal pin disposed on the first side surface and/or the third side surface of the voltage regulator module and located outside the first power pin.

Preferably, further comprising a TLG expansion pin and a TLC extension pin, wherein the TLG extension pin and the TLC extension pin are arranged at positions close to two or four corners of the bottom surface of the voltage regulator module.

Preferably, wherein the first power pin, the second power pin, and the output pin are arranged in two columns, each column is arranged according to a sequence of the first power pin, the second power pin, the output pin, the second power pin and the first power pin; a signal pin, a TLG extension pin, a TLC expansion pin and an auxiliary output pin are further arranged around the two columns of pins, the auxiliary output pin is respectively arranged on the second side surface and the fourth side surface of the voltage regulator module, the TLG extension pin is arranged between the auxiliary output pins located on the second side surface, the TLC extension pin is arranged between the auxiliary output pins located on the fourth side surface, and the signal pins are arranged on the first side surface and the third side surface.

Preferably, wherein the pins are arranged in a pin array or a BGA array, the output pins are arranged in an array of m*n pins, and m and n are natural numbers greater than 1; the second power pin is arranged in two columns along the second side surface and the fourth side surface, and the first power pin is arranged in two rows along the first side surface; the pin further comprises a signal pin, a TLG extension pin and a TLC extension pin; the TLG extension pin and the TLC extension pin are arranged adjacent to the first side surface and are respectively located between the first power pin and the second power pin, and the signal pin is arranged along the third side surface.

Compared with the prior art, the application has the following beneficial effects:

The present application provides a module structure with high efficiency and good heat dissipation performance, which improves the heat dissipation capability of the VRM by means of the design of the self-contained heat sink, so as to improve the output power of the VRM; by means of the device placement in the VRM, the parasitic parameters on the power transmission path are reduced, and the conversion efficiency of the VRM module is improved; and the dynamic performance of the VRM module is further improved by means of the TLVR technology.

The present application further provides a control method of the VRM, which can reduce the current ripple of the input end and the output end, and reduce the number of the input capacitor and the output capacitor by means of controlling the four phases of the VRM working alternately in a 90° out of phase through two control signals with 180° phase shift.

The present application further provides an intelligent power module placement and pin arrangement, which can reduce the volume of the VRM and short the power transmit path by means of adjusting the positions of the switches and the drive/logic circuit of the intelligent power module and adjusting the pins layout, and the conversion efficiency of the VRM is improved.

### BRIEF DESCRIPTION OF THE DRAWINGS

FIG. 1A is a circuit schematic diagram of a four-phase VRM module;

FIG. 1B is a circuit schematic diagram of a four-phase VRM module with TLVR;

FIGS. 2A-2E are one embodiment of a VRM module;

FIGS. 3A-3B are another embodiment of a VRM module;

FIGS. 4A-4B are another embodiment of a VRM module;

FIGS. 5A-5D are another embodiment of a VRM module;

FIGS. 6A-6G are another embodiment of a VRM module;

FIGS. 7A-7D are internal layout extension implementations of the top substrate;

FIG. 8 is an expanded implementation of the top surface layout of the top assembly;

FIGS. 9A-9D are expanded implementations of a top surface layout of a bottom assembly;

FIG. 9E to FIG. 9F are embodiments of a bottom surface layout of the bottom assembly;

FIGS. 10A-10B are functional block diagrams of a four-phase VRM module with TLVR.

### DESCRIPTION OF THE EMBODIMENTS

Technical solutions in the embodiments of the present disclosure will be clearly and completely described below with reference to the accompanying drawings in the embodiments of the present disclosure. Apparently, the described embodiments are merely some rather than all of the embodiments of the present disclosure. All other embodiments obtained by a person of ordinary skill in the art based on the embodiments of the present disclosure without creative efforts shall fall within the protection scope of the present disclosure.

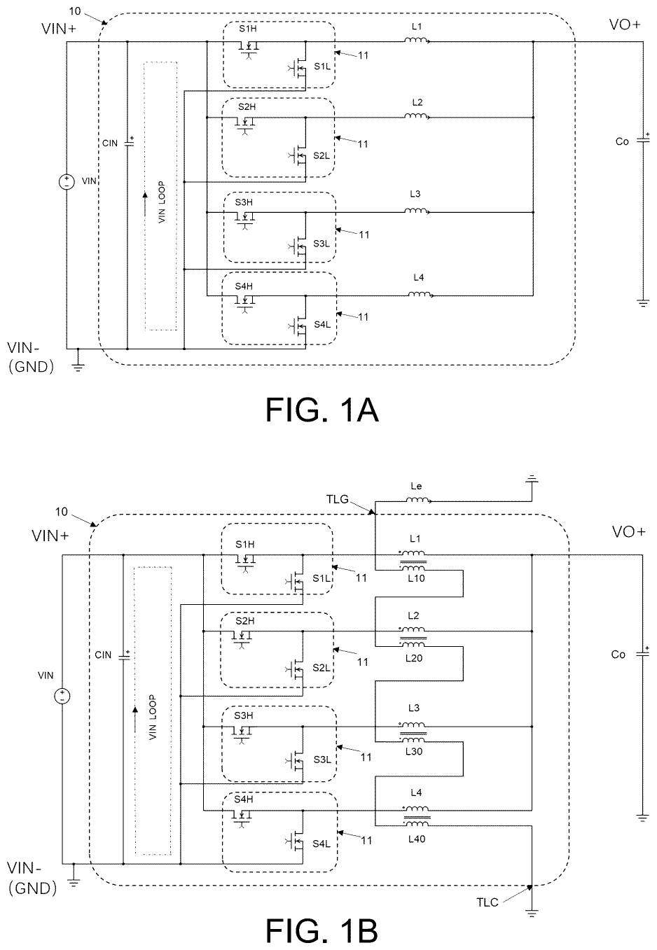

FIG. 1A is a circuit schematic diagram of a four-phase voltage regulator module (VRM) according to the present application. The four-phase VRM circuit comprises four Buck circuits electrically connected in parallel, and each phase Buck circuit comprises an Integrated Power Module 11 (Hereinafter referred to as the IPM, i.e. Dr. MOS), an output inductor, and an input capacitor Cin shared by the four Buck circuits. Each intelligent power module 11 comprises a high-side switch SxH, a low-side switch SxL, and a driving and logic circuit (not shown in the figure); here, x is related to the number of phases of the Buck circuits. A drain electrode of the high-side switch is electrically connected to a positive terminal VIN+, and a source electrode of the low-side switch is electrically connected to an input negative terminal VIN− (i.e. a GND terminal); a source of the high-side switch is electrically connected to a drain of the low-side switch as an output end of the IPM denoted as a Switching Node (SW point); and an input end of the main winding Lx of the output inductor is electrically connected to the SW point, an output end of the main winding Lx of the output inductor is used as an output positive terminal VO+ of the VRM, and is connected to one end of the load to provide energy for the load. In the present disclosure, the switch is illustrated by using a MOSFET as an example, but is not limited thereto.

The four output inductors in the four-phase voltage regulator module of the present application may be four mutually independent inductors, that is, there is no magnetic coupling or weak positive coupling between the main windings L1, L2, L3, and L4 of the four output inductors, for example, the coupling coefficient is less than 0.2. Here, the number of phases of the parallel Buck circuit is not limited to 4 phases, as long as the number of phases of the parallel Buck circuit is greater than or equal to the 2-phase module, and the same technical effect can be obtained. The IPM of the 4 phases in the dashed box 10 as shown in FIG. 1A is controlled by using 4 PWM control signals, a phase shift between two PWM control signals of adjacent phases is 360 degrees/4, that is, 90 degrees; when the module is N phases of Buck circuits connected in parallel (N is a natural number greater than 1), the phase shift between two PWM control signals of adjacent phases is 360 degrees/N.

As shown in FIG. 1A, the drain electrode of the high-side switch in the intelligent power module 11 is electrically connected to the positive terminal VIN+, and the source electrode of the low-side switch is electrically connected to the input negative terminal VIN− (i.e. the GND terminal); in a loop from the input positive terminal VIN+, to the IPM, then to the input negative terminal VIN−, there is a parasitic resistance and parasitic inductance; reducing the parasitic resistance and reasonable selection of the parasitic inductance helps to improve efficiency.

In FIG. 1A, the loss on the IPM is the maximum and the Dr. MOS is the maximum heat source in VRM. Therefore, the most effective method to improve the output power of the VRM is to improve the heat dissipation performance of the Dr. MOS, that is, reduce the thermal resistance of the IPM, thereby reducing the upward thermal resistance Rthj_top of the VRM.

FIG. 1B is on the basis of FIG. 1A, one auxiliary winding L10, L20, L30 and L40 are added for the main windings L1, L2, L3 and L4 respectively; the auxiliary windings are strongly coupled to the corresponding main windings, that is, L10 is strongly coupled to L1, L20 is strongly coupled to L2, L30 is strongly coupled to L3, and L40 is strongly coupled to L4; and connect the auxiliary winding of each phase end to end in series to form a loop, so as to implement TLVR technology, so that the main windings L1, L2, L3, and L4 that originally have no coupling relationship with each other are equivalent to the technical effect of four opposite coupling, so as to obtain a smaller dynamic inductance to improve the dynamic performance of the module output voltage, and a higher steady-state inductance can be achieved to achieve high efficiency.

In practical applications, a first end of the auxiliary winding L10 and the input end of the main winding L1 have the same polarity, and are labeled as point ends; a first end of the auxiliary winding L20 and the input end of the main winding L2 have the same polarity, and are marked as point ends; a first end of the auxiliary winding L30 and the input end of the main winding L3 have the same polarity, and are marked as point ends; and a first end of the auxiliary winding L40 and the input end of the main winding L4 have the same polarity, and are marked as point ends. Auxiliary windings L10, L20, L30 and L40 are connected end to end to obtain a series branch of the auxiliary windings, that is, a second end of L10 is connected to the first end of L20, a second end of L20 is connected to the first end of L30, and a second end of L30 is connected to the first end of L40; one end of the series branch of the auxiliary windings, that is, the first end of L10 is marked as a TLG; and the other end of the series branch of the auxiliary windings, that is, the second end of L40, is marked as TLC. A corresponding TLG pin and TLC pin may be provided on each four-phase voltage regulator module, so that the series branches of auxiliary windings between the plurality of modules having TLVR are further connected in series to each other, so as to realize more phases TLVR power supply solution. In FIG. 1B, the TLG is connected to one end of the external inductor Le; the other end of the Le is connected to the GND terminal; the TLC is also connected to the GND terminal, so that the series branch of the auxiliary windings forms a closed loop by means of the external inductor Le and the GND end. The external inductor Le is configured to improve steady-state inductance and dynamic inductance of the four-phase voltage regulator module.

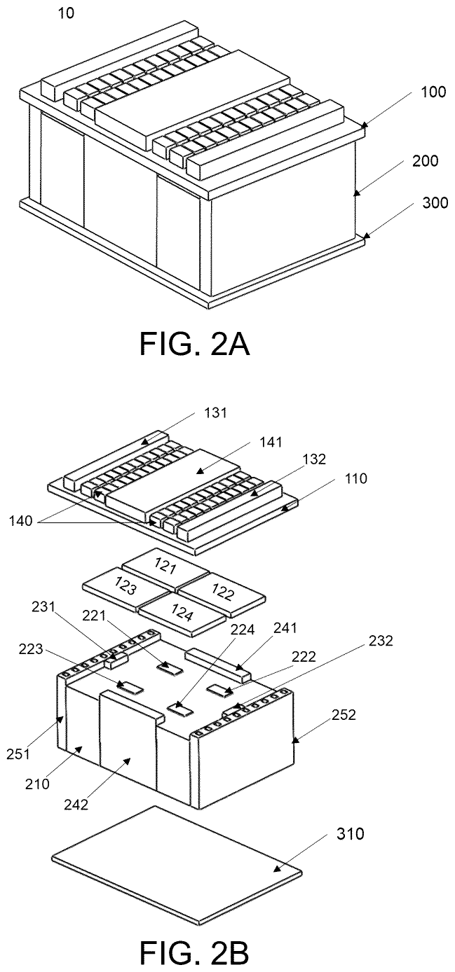

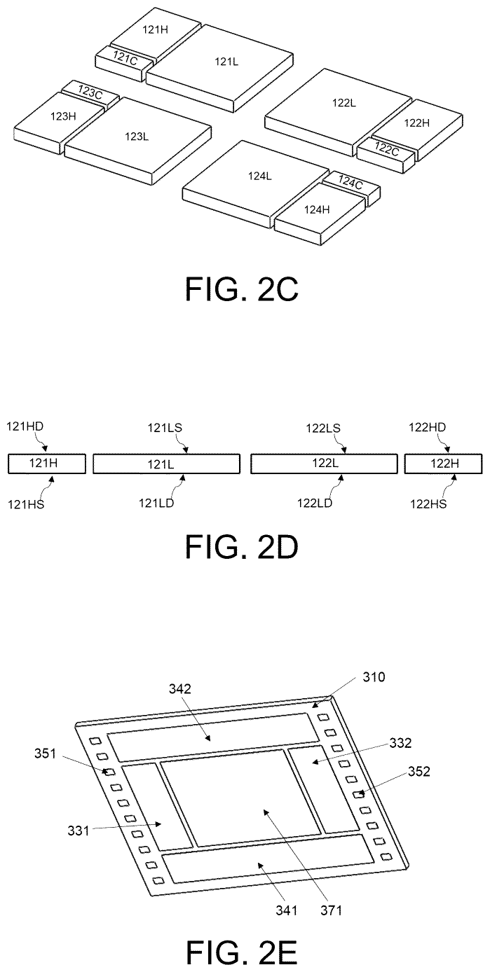

The present application further discloses a structure of the four-phase VRM, as shown in FIGS. 2A-2B, and FIG. 2B is an exploded schematic diagram of FIG. 2A. As shown in FIGS. 2A and 2B, the four-phase VRM comprises a top assembly 100, a middle assembly 200 and a bottom assembly 300; the top assembly 100 comprises a top substrate 110, Driver MOSFETs 121, 122, 123 and 124 (i.e. the intelligent power module 11 in FIGS. 1A and 1B, hereinafter referred to as IPM), an input capacitor 140, first heat dissipation copper blocks 131 and 132, and a second heat dissipation copper block 141; the top substrate 110 has a top surface and a bottom surface opposite to each other. IPM 121, 122, 123 and 124 are provided on the bottom surface of the top substrate 110; IPM 121, 122, 123 and 124 comprise opposite top and bottom surfaces, and the top surface of IPM is electrically connected to the bottom surface of the top substrate 110. The input capacitor 140 and the heat dissipation copper blocks 131, 132 and 141 are provided on the top surface of the top substrate 110, and both the input capacitor and the heat dissipation copper block are attached to and electrically connected to the top substrate. IPM 121, 122, 123 and 124 are arranged in a 2×2 array manner; and the second heat dissipation copper block 141 is arranged between the first heat dissipation copper block 131 and the first heat dissipation copper block 132.

A middle assembly 200 comprises a magnetic core 210, a first winding 221, a second winding 222, a third winding 223, a fourth winding 224, and first power electrical connectors 231 and 232; second power electrical connectors 241 and 242 and signal electrical connectors 251 and 252. The aforementioned windings correspond to the main windings of the four output inductors in FIGS. 1A and 1B. A first pin of the first winding 221 is electrically connected to the bottom surface of the first IPM 121, a first pin of the second winding 222 is electrically connected to the bottom surface of the second IPM 122, a first pin of the third winding 223 is electrically connected to the bottom surface of the third IPM 123, and a first pin of the fourth winding 224 is electrically connected to the bottom surface of the fourth IPM 124. Second pins of the first winding 221 to the fourth winding 224 are all shorted together by a bottom substrate 310 in the bottom assembly 300, and are electrically connected to the load to provide energy for the load. The first power electrical connectors 231 and 232 are disposed on two opposite side surfaces of the magnetic core, the first power electrical connectors 231 and 232 are respectively disposed adjacent to the first heat dissipation copper blocks 131 and 132, and the first pins of the first power electrical connectors 231 and 232 are respectively electrically connected to the first heat dissipation copper blocks 131 and 132 above the top substrate by means of the top substrate 110; the second power electrical connectors 241 and 242 are provided on the other two opposite sides of the magnetic core, and the first pins of the second power electrical connectors 241 or 242 are electrically connected to the second heat dissipation copper block 141 above the top substrate by means of the top substrate 110. The signal electrical connectors 251 and 252 are disposed adjacent to the first power electrical connectors 231 and 232, respectively, and the first pins of the signal electrical connectors 251 and 252 are electrically connected to the IPM through the top substrate 110, and the second pins thereof are electrically connected to the bottom substrate 310 of the bottom assembly 300.

FIG. 2C is a schematic structural diagram of a IPM which is a bare chip in a packaging material or embedded in a package substrate, and FIG. 2D is a side view of FIG. 2C. With reference to FIGS. 2C and 2D, the first IPM 121 includes a high-side MOSFET 121H, a low-side MOSFET 121L, and a driving/logic circuit 121C; the second IPM 122 includes a high-side MOSFET 122H, a low-side MOSFET 122L and a driving/logic circuit 122C; the third IPM 123 includes a high-side MOSFET 123H, a low-side MOSFET 123L, and a driving/logic circuit 123C; the fourth IPM 124 includes a high-side MOSFET 124H, a low-side MOSFET 124L and a driving/logic circuit 124C. The high-side MOSFET and the low-side MOSFET are both vertical MOSFETs; the drain of the high-side MOSFET is disposed on the top surface of the MOSFET, such as 121HD, 122HD, 123HD and 124HD, and the source of the high-side MOSFET is disposed on the bottom surface of the MOSFET, such as 121HS, 122HS, 123HS and 124HS; the drain of the low-side MOSFET is disposed on the bottom surface of the MOSFET, such as 121LD, 122LD, 123LD and 124LD, and the source of the low-side MOSFET is disposed on the top surface of the MOSFET, such as 121LS, 122LS, 123LS and 124LS. Four low-side MOSFETs of the four IPM are disposed adjacent to each other, so that the sources of the four low-side MOSFETs can be shorted together nearby on the top substrate 110; and the four low-side MOSFETs can be integrated on one wafer. The high-side MOSFET of each IPM is adjacent to the respective low-side MOSFET such that the source of the high-side MOSFET of each IPM and the drain of the low-side MOSFET are shorted together nearby; the driving/logic circuit of each IPM is placed side-by-side with the high-side MOSFET and is adjacent to the low-side MOSFET, so that the driving/logic circuit can drive the high-side MOSFET and the low-side MOSFET nearby. In FIG. 2C, some driving/logic circuits are placed on the right side of the high-side MOSFET, specifically as shown in IPM 123; some driving/logic circuits can also be placed on the left side of the high-side MOSFET, specifically as shown in IPM 121. Such an advantage is that the driving/logic circuits 123C are adjacent to 121C, and further 123 C and 121 C can be integrated on one wafer.

As shown in FIG. 1A, the drain of the high-side MOSFET is electrically connected to the positive terminal VIN+, the source of the low-side MOSFET is electrically connected to the input negative terminal Vin−, and the source of the high-side MOSFET and the drain of the low-side MOSFET are both electrically connected to the input terminal of the output inductor. Therefore, in the present embodiment, the first power electrical connector 231 is electrically connected to the drains 121HD and 123HD of the high-side MOSFETs by means of the top substrate 110, and the first power electrical connector 232 is electrically connected to the drains 122HD and 124HD of the high-side MOSFETs by means of the top substrate 110. The second power electrical connectors 241 and 242 are electrically connected to the source 121LS, 122LS, 123LS and 124LS of the low-side MOSFET by the top substrate 110, respectively.

The first pin of the first winding 221 is electrically connected to the source 121HS of the high-side MOSFET and the drain 121LD of the low-side MOSFET on the bottom of the first IPM 121, the first pin of the second winding 222 is electrically connected to the source 122HS of the high-side MOSFET and the drain 122LD of the low-side MOSFET on the bottom of the second IPM 122, the first pin of the third winding 223 is electrically connected to the source 123HS of the high-side MOSFET and the drain 123LD of the low-side MOSFET on the bottom of the third IPM 123, the first pin of the fourth winding 224 is electrically connected to the source 124HS of the high-side MOSFET and the drain 124LD of the low-side MOSFET on the bottom of the fourth IPM 124.

According to the foregoing placement and connection mode, the input power is transmitted to the high-side MOSFET of the IPM by means of the first power electrical connector, and then the low-side MOSFET is electrically connected to the second power electrical connector, the vertical arrangement of the output inductor, and the input end of the output inductor thereof is electrically connected to the SW pin of the IPM, thereby reducing the direct-current impedance of the input loop and the output loop, and improving the efficiency of the VRM; the first heat dissipation copper blocks 131 and 132 provided on the top surface of the top assembly are electrically connected to the drain of the high-side MOSFET on the top substrate, and the second heat dissipation copper block 141 is electrically connected to the source of the low-side MOSFET on the top substrate; and the arrangement of the copper blocks enables the direct current impedance of the power path in the top substrate to be reduced, thereby further reducing the loss of the VRM.

Further, a VIA or a copper column is provided in the top substrate, the first heat dissipation copper block and the second heat dissipation copper block are vertically electrically connected to the high-side MOSFET and the low-side MOSFET of the IPM by means of the via or the copper column, thereby further reducing the thermal resistance of the MOSFET to the top surface of the module; specifically, the first heat dissipation copper block 131 is vertically electrically connected to the drain of the high-side MOSFET 121H and the drain of the high-side MOSFET 123H, and the first heat dissipation copper block 132 is vertically electrically connected to the drain of the high-side MOSFET 122H and the drain of the high-side MOSFET 124H; and the first heat dissipation copper blocks 131 and 132 are shorted together inside the top substrate 110. The second heat dissipation copper block 141 is vertically electrically connected to the sources of the four low-side MOSFETs 121L, 122L, 123L, and 124L. The height of the heat dissipation copper block is close to or slightly higher than the height of the input capacitor 140, so that the height of the top device of the four-phase VRM is approximately the same; therefore, in the application of assembling the thermal pad and the heat sink on the top of the four-phase VRM, the thermal resistance between the IPM and the thermal pad in the four-phase VRM is reduced; and the heat-dissipation copper block can bear most of the pressure transmitted from the heat sink and the thermal pad to the four-phase VRM, thereby reducing the stress of the input capacitor 140. By means of the above arrangement, a heat dissipation path of low thermal resistance is provided for the heat source MOSFET, and the output power of the VRM is further improved, that is, at the same output voltage, a larger output current can be provided. Since the turn-on time of the low-side MOSFET is longer in the BUCK circuit, the loss on the low-side MOSFET is larger, so that the second heat dissipation copper block 141 electrically connected to the low-side MOSFET has a larger volume, so that the heat dissipation of the VRM is more balanced.

The input capacitor 140 is arranged on the top surface of the top assembly, the input capacitor 140 is connected across the input positive terminal VIN+ and the input negative terminal Vin− (i.e. the GND terminal), that is, the positive terminal of the input capacitor is electrically connected to the input positive terminal VIN+ close to the drain of the high-side MOSFET, and the negative terminal of the capacitor thereof is electrically connected to the GND terminal close to the source of the low-side MOSFET; the input capacitor in this electrical connection manner is used to minimize the loop between the input capacitor and the MOSFET, so that the inductance of the parasitic inductor on the loop path is further reduced, and the effect of high-frequency filtering is improved; moreover, due to the small inductance of the parasitic inductor, the voltage spike caused by high-frequency oscillation is small, which is beneficial to the reliability of the module; in addition, the energy loss caused by high-frequency oscillation is also reduced, and the conversion efficiency of the VRM is further improved. The input capacitor 140 is arranged between the first heat dissipation copper block 131 and the second heat dissipation copper block 141, or the input capacitor 140 is arranged between the first heat dissipation copper block 132 and the second heat dissipation copper block 141, so that the four-phase VRM surface forms a layout of the first heat dissipation copper block, the input capacitor, the second heat dissipation copper block, the input capacitor, and the first heat dissipation copper block in sequence.

FIG. 2E is a schematic diagram of a pin of the bottom substrate 310 in a bottom assembly, a bottom surface of the bottom substrate 310 is provided with first power pins 331 and 332, second power pins 341 and 342, output pin 371 and signal pins 351 and 352. The first power pins 331 and 332 are respectively electrically connected to the second pins of the first power electrical connectors 231 and 232 on the top surface of the bottom substrate 310, the second power pins 341 and 342 are respectively electrically connected to second pins of the second power electrical connectors 241 and 242 on the top surface of the bottom substrate 310, and the output pins are electrically connected to the second pins of the four windings on the top surface of the bottom substrate 310. The output pin 371 is surrounded by the first power pins 331, 332 and the second power pins 341, 342. The signal pins 351 and 352 are electrically connected to the second pins of the signal connectors 251 and 252 on the top surface of the bottom substrate 310; and the signal pins 351 and 352 are respectively located on the outer sides of the first power pins 331 and 332, and respectively satisfy the parallel relationship with the first power pins 331 and 332. In practical applications, at least one first power electrical connector, at least one second power electrical connector, and at least one signal electrical connector may be selected to achieve the same technical effect.

In the present embodiment, the signal electrical connector is implemented in the form of a vertical plate by using a printed circuit board; the first pin of the power electrical connector and the first pin of the signal electrical connector are directly electrically connected to the bottom surface of the substrate in the top assembly, and the first pin of the winding is electrically connected to the bottom surface of the IPM on the bottom surface of the top substrate, thus, the first pins of the power electrical connectors 231, 232, 241 and 242 and the first pins of the signal electrical connectors 251 and 252 have the same height, and the upper end faces of the electrical connectors are all higher than the first pin end faces of the windings 221, 222, 223, and 224.

In the present embodiment, the first power electrical connectors 231 and 232 are respectively located on two opposite sides of the magnetic core 210 in a first direction; the second power electrical connectors 241 and 242 are respectively located on two opposite sides of the magnetic core 210 in a second direction; the first direction of the magnetic core 210 is perpendicular to the second direction of the magnetic core 210; and the signal electrical connectors 251 and 252 are also located on two opposite sides of the magnetic core 210 in the first direction, and are located on the outer sides of the first power electrical connectors 231 and 232. According to the placement method, the distance between the first power electrical connectors 231 and 232 and the second power electrical connector 241 and 242 is relatively far, that is, the loop between the first power electrical connectors and the second power connectors is large, and the parasitic inductance is large. In other embodiments, in this case, the first power electrical connectors 231 and 232 can also be moved to two opposite sides in the second direction of the magnetic core 210, such that the first power electrical connectors 231 and 232 are adjacent to the second power electrical connectors 241 and 242, respectively, so that the loop between the first power electrical connector and the second power connector is small, and the parasitic inductance is small. Further, the first power electrical connector 231 may also be disposed on both sides of the second power electrical connector 241; the first power electrical connector 232 is disposed on both sides of the second power electrical connector 242.

### Embodiment 2

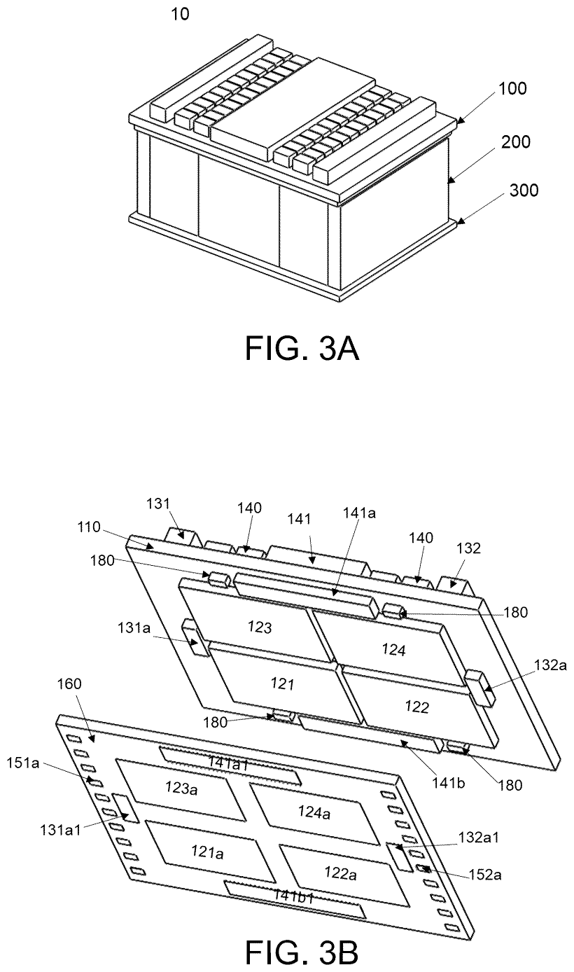

FIG. 3A and FIG. 3B are schematic structural diagrams of another embodiment, and the module 10 shown in this embodiment has the same technical effect as the module shown in FIG. 2A. As shown in FIG. 3A, the module 10 comprises a top assembly 100, a middle assembly 200 and a bottom assembly 300. FIG. 3B is a structural exploded view of the top assembly 100 of FIG. 3A, the top assembly 100 comprises a top substrate 110, IPM 121, 122, 123 and 124, an input capacitor 140, first heat dissipation copper blocks 131 and 132, a second heat dissipation copper block 141, copper columns 131a, 132a, 141a and 141b, and a plastic package 160. The top substrate 110 have opposite top and bottom surfaces, the bottom surface of the top substrate 110 is provided with IPM 121, 122, 123 and 124, and each IPM 121, 122, 123 and 124 also has opposite top and bottom surfaces, and the top surfaces of IPM 121, 122, 123 and 124 are electrically connected to the bottom surface of the top substrate 110; the top surface of the top substrate 110 is provided with the input capacitor 140 and the heat dissipation copper blocks 131, 132 and 141, and the input capacitor and the heat dissipation copper blocks are electrically connected to the top substrate. Copper columns 131a, 132a, 141a and 141b are provided on the bottom surface of the top substrate 110, the copper columns 131a and 132a are electrically connected to the heat dissipation copper blocks 131 and 132 respectively by means of the substrate 110, and the copper columns 141a and 141b are electrically connected to the heat dissipation copper block 141 by means of the substrate 110. The bottom surface of the top substrate is further provided with a high-frequency capacitor 180, and the high-frequency capacitor is adjacent to IPM 121, 122, 123 and 124. This arrangement can further filter out high-frequency ripple, eliminate the voltage spike caused by high-frequency oscillation, and further improve the reliability of the module.

In the present embodiment, IPM 121, 122, 123, 124 and copper columns 131a, 132a, 141a, 141b are molded together by means of a plastic package 160, and the surface of the plastic package 160 is formed with pins (or pads) 121 a, 122 a, 123 a, 124 a, 131a1, 132a1, 141a1, 141b1, 151a and 152a by means of a metallization method; the pins 121a, 122a, 123a and 124a are electrically connected to the bottom of the IPM 121, 122, 123 and 124, respectively, i.e. electrically connected to the source of the high-side MOSFET and the drain of the low-side MOSFET; pins 131a, 132a1, 141a1 and 141b1 are electrically connected to copper columns 131a, 132a, 141a and 141b, respectively; pins 151a, 152a are electrically connected to the top substrate 110 by means of drilling and electroplating.

According to the present implementation, all pins are arranged on the same plane by means of a plastic packaging process, and therefore, the pins of the power electrical connector of the middle assembly and the pins of the winding, and the pins of the signal electrical connector need only be arranged on the same plane, simplifying the manufacturing process of the middle assembly, so as to improve the manufacturability of the product and reduce the manufacturing cost.

### Embodiment 3

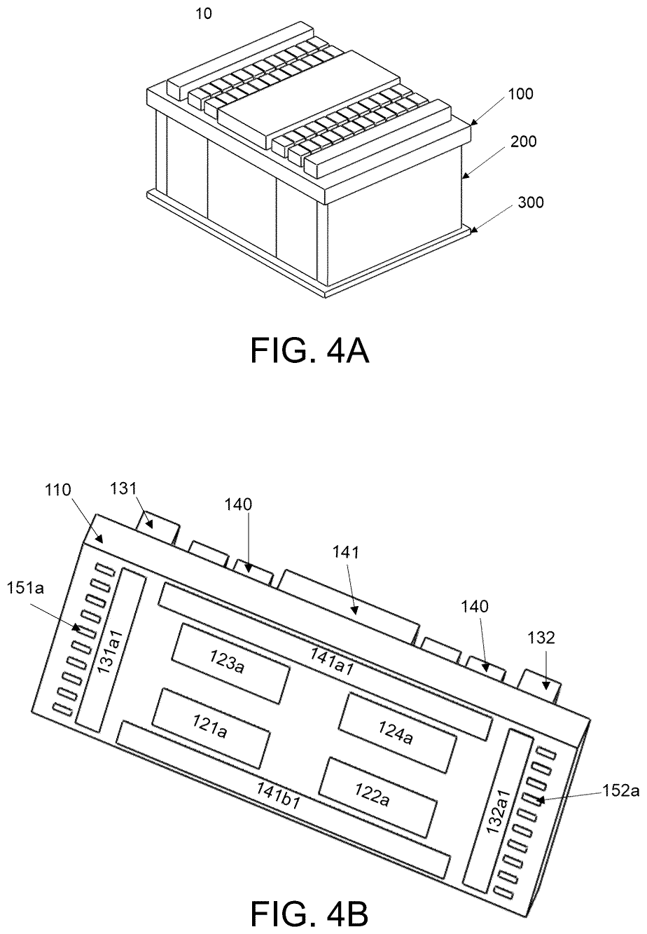

FIG. 4A is a schematic structural diagram of another embodiment of the present disclosure, and the module 10 described in this embodiment has the same technical effect as the embodiment described in FIG. 2A. As shown in FIG. 4A, the module shown in this embodiment also includes a top assembly 100, a middle assembly 200, and a bottom assembly 300. The difference between this embodiment and the embodiment shown in FIG. 2A is that the top assembly 100. FIG. 4B is an exploded view of the top assembly 100 in FIG. 4A. As shown in FIG. 4B, the top assembly 100 comprises a top substrate 110, IPM 121, 122, 123 and 124, an input capacitor 140, first heat dissipation copper blocks 131 and 132, and a second heat dissipation copper block 141; IPM 121, 122, 123 and 124 are embedded within the substrate 110 (the layout of IPM is shown in FIGS. 2C and 2D, not shown in the present embodiment). The IPM provided in the top substrate 110 is electrically connected to the heat dissipation copper block and the capacitor on the top surface of the substrate 110 by means of the RDL, and pins 121a, 122a, 123a and 124a of the IPM are formed by the RDL on the bottom surface of the substrate 110, and the pins 121a, 122a, 123a and 124a are electrically connected to the bottom of the IPM 121, 122, 123 and 124, respectively, that is, electrically connected to the source of the high-side MOSFET and the drain of the low-end MOSFET, and the pins 121a, 122a, 123a and 124a are electrically connected to the first pins of the main winding in the middle assembly. The bottom surface of the top substrate 110 is further provided with pins 131a1, 132a1, 141a1, 141b1, 151a and 152a; the pins 131a1 and 132a1 are respectively electrically connected to the first heat dissipation copper blocks 131 and 132; the pins 141a1 and 141b1 are electrically connected to the second heat dissipation copper block 141; and the pins 151a and 152a are respectively electrically connected to the signal pins of the IPM by means of drilling and electroplating. Pins 131a1 and 132a1 are respectively electrically connected to the first pins of the first power electrical connectors 231 and 232 in the middle assembly; pins 141a1 and 141b1 are respectively electrically connected to the first pins of the second power electrical connectors 241 and 242 in the middle assembly; pins 151a and 152a are respectively electrically connected to the first pins of the signal electrical connectors 151 and 152 in the middle assembly. In the present embodiment, the MOSFET is embedded in the substrate, and the connection mode between the MOSFET and the top surface device and the middle assembly of the substrate is the same as that in Embodiment 1, and details are not described herein again. In the present embodiment, the connection path of the input capacitor on the top surface is greatly reduced, the loop area between the MOSFETs is reduced, the inductance of the parasitic inductor of the loop is reduced, the high-frequency filtering effect is further improved, the voltage spike caused by high-frequency oscillation is further reduced, and the operation reliability of the module is improved. In addition, the energy loss caused by oscillation is also reduced, which is beneficial to the improvement of the efficiency of the VRM. In the present embodiment, the pins electrically connected or welded between the top assembly and the middle assembly are arranged on the same plane, thereby reducing the difficulty of manufacturing the middle assembly and facilitating mass production.

### Embodiment 4

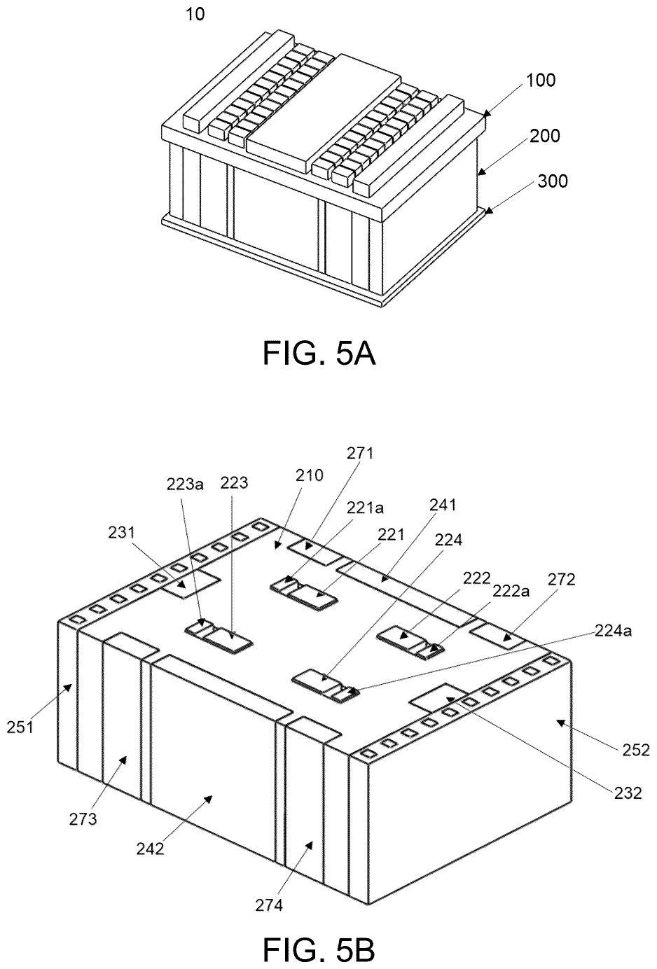

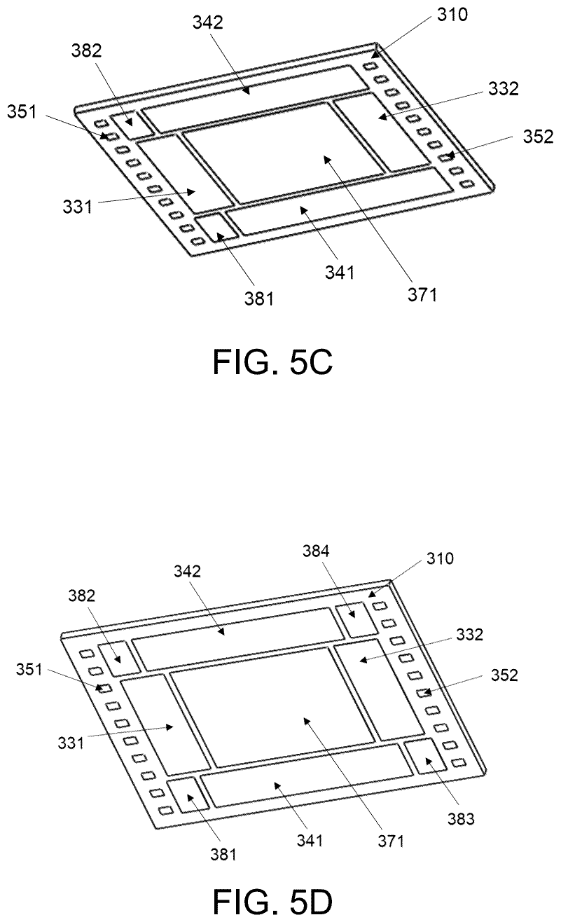

FIG. 5A is a schematic structural diagram of another embodiment of the present application, as shown in FIG. 5A, the module of the present embodiment comprises a top assembly 100, a middle assembly 200 and a bottom assembly 300; the top assembly 100 has the same technical effect as the top assembly 100 in the embodiment described in FIG. 4A; FIG. 5B is a schematic structural diagram of the middle assembly 200 in FIG. 5A, as shown in FIG. 5B, the middle assembly 200 has a magnetic core 210, a first main winding 221, a second main winding 222, a third main winding 223, a fourth main winding 224, a first auxiliary winding 221a, a second auxiliary winding 222a, a third auxiliary winding 223a, a fourth auxiliary winding 224a, first power electrical connectors 231 and 232, second power electrical connectors 241 and 242, auxiliary winding electrical connectors 271, 272, 273 and 274 and signal electrical connectors 251 and 252; the first main winding 221 and the first auxiliary winding 221a are coupled to each other and are located in the same magnetic core hole in parallel; the second main winding 222 and the second auxiliary winding 222a are coupled to each other and are located in the same magnetic core hole in parallel; the third main winding 223 and the third auxiliary winding 223a are coupled to each other and are located in the same magnetic core hole in parallel; and the fourth main winding 224 and the fourth auxiliary winding 224a are coupled to each other and are located in the same magnetic core hole in parallel. The connection manner of the power electrical connector and the signal electrical connector in this embodiment is the same as that in the foregoing embodiment, and details are not described herein again. Auxiliary winding electrical connectors 271, 272, 273 and 274 connecting the auxiliary windings 221a, 222a, 223a and 224a in series by top substrate traces and bottom substrate traces such that the auxiliary windings 221a, 222a, 223a and 224a form an auxiliary winding series loop and ensure that each phase auxiliary winding is positively coupled with a corresponding main winding; the auxiliary winding electrical connector and the second power electrical connectors 241 and 242 are arranged on the same side and are alternately arranged at intervals, specifically, the auxiliary winding electrical connectors 271 and 272 are arranged at two sides of the second power electrical connector 241, and the auxiliary winding electrical connectors 273 and 274 are arranged at two sides of the second power electrical connector 242. The advantage of this arrangement is to improve the coupling between the main winding and the auxiliary winding loop, which helps to reduce the dynamic inductance of the multiphase TLVR, so as to improve the dynamic performance of the output voltage of the multiphase TLVR power supply scheme.

FIG. 5C is a schematic diagram of pins of the bottom substrate 310 in FIG. 5A, as shown in FIG. 5C, the bottom surface of the bottom substrate is provided with first power pins 331 and 332, second power pins 341 and 342, an output pin 371, TLVR function extension pins 381 and 382, and signal pins 351 and 352. The first power pins 331 and 332 are electrically connected to the second pin of the first power electrical connectors 231 and 232 on the top surface of the bottom substrate, the second power pins 341 and 342 are electrically connected to the second pin of the second power electrical connectors 241 and 242 on the top surface of the bottom substrate, and the signal pins 351 and 352 are electrically connected to the second pin of the signal connectors 251 and 252 on the top surface of the bottom substrate; the TLVR function extension pins 381 and 382 are electrically connected to two end pins of the auxiliary winding series loop on the top surface of the bottom substrate, and the TLVR function extension pins 381 and 382 may also be configured as a TLG pin and a TLC pin, and the auxiliary windings for the plurality of modules are connected in series with each other to form a more phases TLVR power supply solution. The TLVR extension pin in this embodiment is arranged on the same side, so that the connection path between the auxiliary winding and the module is shorter, and the inductance of the parasitic inductance in the auxiliary winding loop is smaller, which is more conducive to reducing the dynamic inductance of the multi-phase TLVR power supply scheme.

FIG. 5D is another embodiment of the bottom assembly shown in FIG. 5C; FIG. 5D has the same technical effect as the embodiment in FIG. 5C, and the difference between the embodiment shown in FIG. 5D and FIG. 5C is that the bottom surface of the bottom substrate is further provided with TLVR function extension pins 383 and 384, the TLVR function extension pins 381, 382, 383, and 384 are provided at positions close to four corners of the bottom surface of the substrate, and two or more of the TLVR function extension pins 381, 382, 383 and 384 can be arbitrarily configured as TLG pin and TLC pin, so as to cope with the requirements of different application scenarios for different placement modes of the module; ensuring that the parasitic inductance of the auxiliary winding series connection path is minimized.

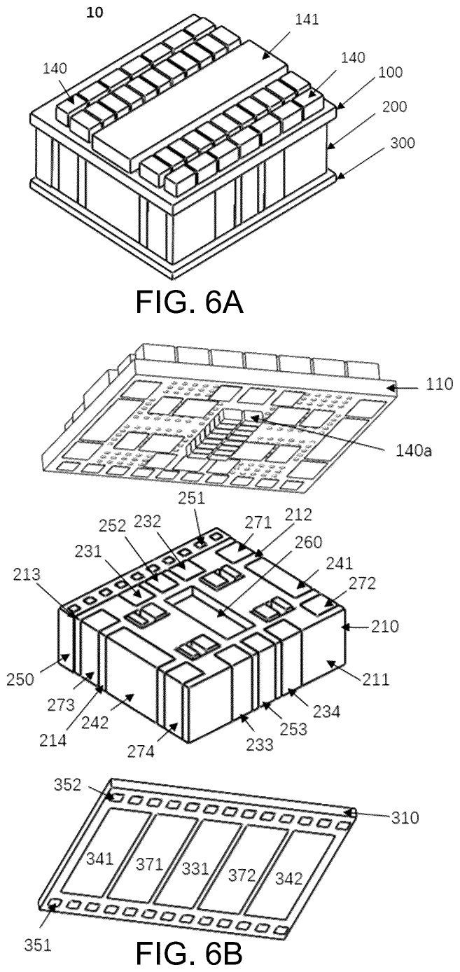

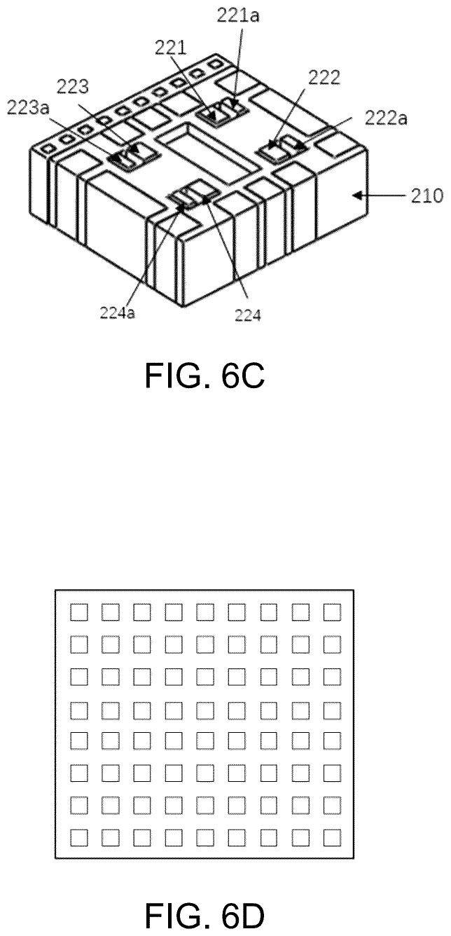

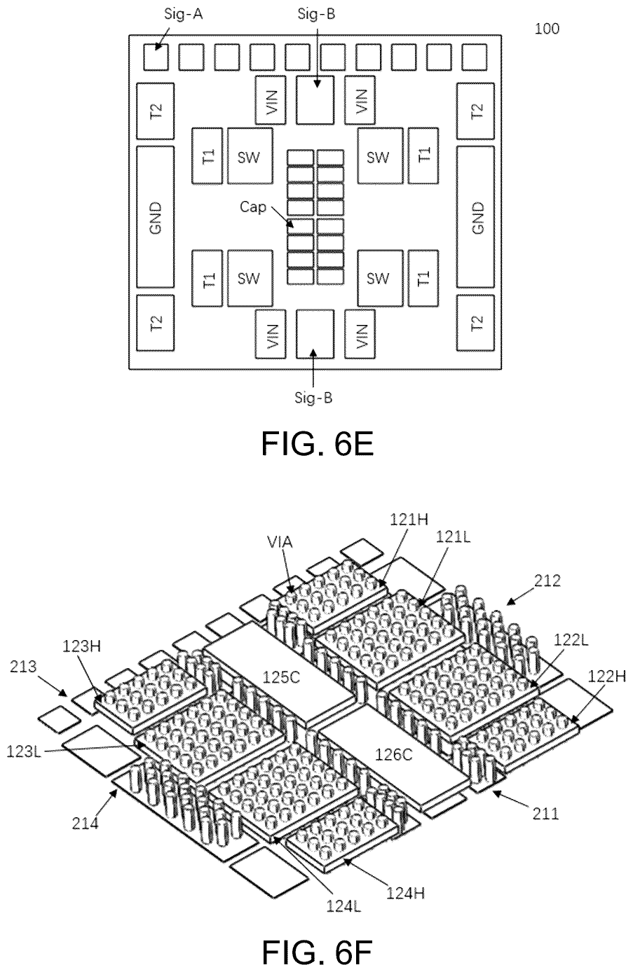

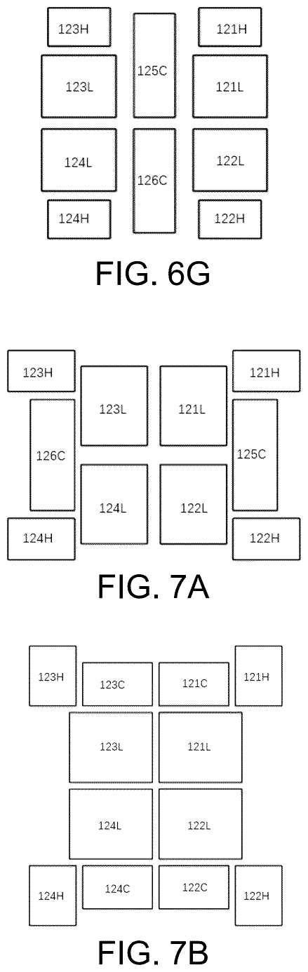

FIG. 6A is a schematic structural diagram of another embodiment of the present application, FIG. 6B is an exploded view of the structure of FIG. 6A, and FIG. 6C is a schematic structural diagram of a middle assembly. With reference to FIGS. 6A and 6B, the module according to the present embodiment comprises a top assembly 100, a middle assembly 200 and a bottom assembly 300; the top assembly 100 comprises a top substrate 110, an input capacitor 140, other passive elements 140a, a second heat dissipation copper block 141, and IPM embedded inside the top substrate 110; the second heat dissipation copper block 141 is arranged in the middle of the top surface of the top substrate 110, and the input capacitor 140 is respectively arranged on two sides of the second heat dissipation copper block 141. The middle assembly 200 comprises a magnetic core 210, a plurality of sets of winding assemblies, first power electrical connectors 231, 232, 233 and 234, second power electrical connectors 241 and 242, auxiliary winding electrical connectors 271, 272, 273 and 274 and signal electrical connectors 251, 252 and 253. As shown in FIG. 6C, the plurality of sets of winding assemblies are a first winding assembly, a second winding assembly, a third winding assembly and a fourth winding assembly, respectively. The first winding assembly comprises a first main winding 221 and a first auxiliary winding 221a, the second winding assembly comprises a second main winding 222 and a second auxiliary winding 222a, the third winding assembly comprises a third main winding 223 and a third auxiliary winding 222a, and the fourth winding assembly comprises a fourth main winding 224 and a fourth auxiliary winding 224a.

The bottom surface of the top substrate 110 is provided with other passive elements 140a, the top of the magnetic core 210 is provided with a groove 260, and the groove 260 is used for accommodating the passive element 140a thereof. The magnetic core 210 further comprises four windows penetrating from the top surface to the bottom surface, and are respectively used for providing the first to fourth winding assemblies. The winding assembly and the magnetic core can be integrally press-formed, and can also be assembled by using a magnetic core and a winding assembly. The first power electrical connectors 231 and 232 are provided at the third side surface 213 of the magnetic core 210, the first power electrical connectors 233 and 234 are provided on the first side surface 211 of the magnetic core 210; the second power electrical connectors 241 and 242 are respectively provided on the second side surface 212 and the fourth side surface 214 of the magnetic core, auxiliary winding electrical connectors 271 and 272 are provided at the second side surface 212, the auxiliary winding electrical connectors 273 and 274 are provided on the forth side surface of the magnetic core. The first signal electrical connector 251 is provided on the vertical plate 250, the second signal electrical connector 252 is disposed on the third side surface 213 of the magnetic core, and the second signal electrical connector 253 is disposed on the first side surface 211 of the magnetic core. The second signal electrical connector and the magnetic core can be assembled together by means of assembling, and the electrical connector and the magnetic core can also be pressed together by means of integrated stamping.

As shown in FIG. 6B, the bottom assembly 300 comprises a top surface and a bottom surface opposite to each other, the top surface of the bottom assembly 300 is attached to the bottom surface of the middle assembly 200, and the bottom surface of the bottom assembly 300 is fixed and electrically connected to an external assembly (such as a system board). The bottom surface of the bottom assembly 300 is also provided with the first power pin 331, the second power pins 341 and 342, output pins 371 and 372, and signal pins 351 and 352; wherein the signal pin 352 may be used for extending pins TLG and/or TLC of the TLVR; and the first power pin, the second power pin and the output pin are all power pins, and the power pins are arranged according to the sequence of the second power pin, the output pin, the first power pin, the output pin, and the second power pin to form a power pin array. The signal pins 351 and 352 are respectively disposed on two opposite sides of the power pin array and are disposed adjacent to two opposite sides of the second power pins 341 and 342. In detail, the power pins are rectangular in shape, the signal pin 351 are disposed adjacent to the first side surface 211 of the magnetic core, and the signal pins 352 are disposed adjacent to the third side surface 213 of the magnetic core; the second power pins 341 are disposed adjacent to the fourth side surface 214, and the second power pins 342 are disposed adjacent to the second side surface 212.

FIG. 6D is a schematic layout diagram of the bottom surface of the bottom assembly 300, the M*N LGA (Land Grid Array) pins are arranged on the bottom surface of the bottom assembly 300, the definition of each LGA pin can be designed according to the actual requirements of the customer, and the LGA pins are electrically connected to the pins of the top surface of the bottom assembly by means of the bottom assembly. The LGA pin is used to facilitate the welding of the customer on the system board, thereby further improving the product yield and reliability of the module.

FIG. 6E shows a pin map of the bottom surface of the top assembly 100, and referring to the top surface of the middle assembly 200 shown in FIG. 6B and FIG. 6C, four SW pins and four T1 pins are provided on the bottom surface of the top assembly 100, the positions of the SW pins are in one-to-one correspondence with the positions of the windings 221, 222, 223, and 224 of the middle assembly, and the SW pins are used for realizing the electrical connection between the windings and the IPM; the positions of the T1 pins are in one-to-one correspondence with the positions of the auxiliary windings 221a, 222a, 223a and 224a, and the T1 pins are used for realizing the electrical connection between the auxiliary winding and the internal wiring of the top assembly. The bottom surface of the top assembly 100 is further provided with four T2 pins, the positions of the four T2 pins and the positions of the four auxiliary winding electrical connectors 271, 272, 273 and 274 are in one-to-one correspondence, and the four T2 pins are used for realizing the electrical connection between the auxiliary winding electrical connector and the internal wiring of the top assembly. The bottom surface of the top assembly 100 is further provided with four VIN pins, two GND pins, a first signal pin Sig-A and a second signal pin Sig-B; the arrangement positions of the four VIN pins are in one-to-one correspondence with the positions of the first power electrical connectors 231, 232, 233 and 234 of the top surface of the middle assembly, and the four VIN pins are used for electrically connecting the first power electrical connectors; the arrangement positions of the two GND pins are in one-to-one correspondence with the positions of the second power electrical connectors 241 and 242, and the GND pins are used for electrically connecting the second power electrical connectors; the positions of the first signal pins Sig-A correspond to the positions of the vertical plates 250 and the first signal pin Sig-A are used for electrically connecting the first signal electrical connector 251; the positions of the second signal pins Sig-B correspond to the positions of the second signal electrical connectors 252 and 253 on a one-to-one basis, and are used for electrically connecting the second signal electrical connectors 252 and 253.

FIG. 6F is an internal schematic diagram after a substrate material in a top assembly is removed from the substrate according to an embodiment, and FIG. 6G is an internal layout diagram in the substrate 110. With reference to FIGS. 6F and 6G, the first IPM includes a high-side MOSFET 121H and a low-side MOSFET 121L, the second IPM includes a high-side MOSFET 122H and a low-side MOSFET 122L, and the third IPM includes a high-side MOSFET 123H and a low-side MOSFET 123L, and the fourth IPM includes a high-side MOSFET 124H and a low-side MOSFET 124L. The four low-side MOSFETs are arranged in a 2×2 array, and the four IPMs are also arranged in a 2×2 array. The arrangement of the source and the drain of the high-side MOSFET and the low-side MOSFET refers to FIG. 2C and FIG. 2D, and details are not described herein again. Driving/logic circuits 125C and 126C are arranged between IPMs, and each driving/logic circuit respectively controls any two of the four IPMs, each IPM is electrically connected to the via, and the via extends to the surface of the substrate and is electrically connected to the surface wiring of the substrate. The first high-side MOSFET 121H, the first low-side MOSFET 121L, the second low-side MOSFET 122L, and the second high-side MOSFET 122H are sequentially arranged from the third side surface 213 to the first side surface 211, the third high-side MOSFET 123H, the third low-side MOSFET 123L, the fourth low-side MOSFET 124L, and the fourth high-side MOSFET 124H are sequentially arranged from the third side surface 213 to the first side surface 211. The driving/logic circuit 125C is disposed between the first IPM and the third IPM, and the driving/logic circuit 126C is disposed between the second IPM and the fourth IPM.

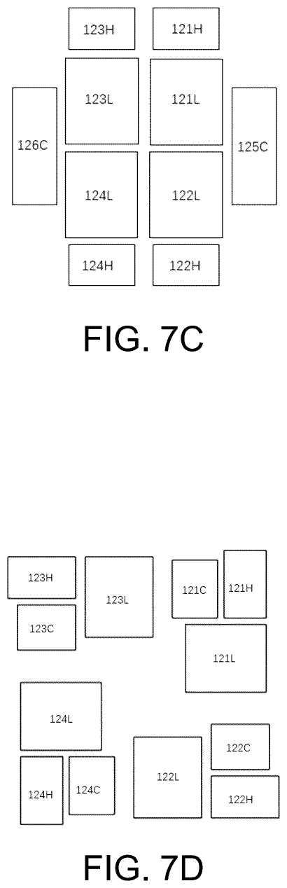

FIGS. 7A-7D are other embodiments of an internal IPM placement in the substrate 110. Specifically, FIG. 7A shows another embodiment of the internal placement in the substrate 110, the four low-side MOSFETs are arranged in an array of 2×2, and are disposed in the middle of the substrate 110; the four high-side MOSFETs are respectively disposed at four corners of the 2×2 low-side MOSFET array, and are respectively disposed adjacent to the corresponding low-side MOSFET. The driving/logic circuit 125C is arranged between the first high-side MOSFET 121H and the second high-side MOSFET 122H, and is used for driving the turn-on and turn-off of the first IPM and the second IPM; the driving/logic circuit 126C is provided between the third high-side MOSFET 123H and the fourth high-side MOSFET 124H for driving the turn-on and turn-off of the third IPM and the fourth IPM; the two driving/logic circuits are disposed adjacent to the second side surface 212 and the fourth side surface 214, respectively.

Another embodiment of the internal IPM placement in the substrate 110 shown in FIG. 7B. Different from FIG. 7A in that four driving/logic circuits 121C, 122C, 123, and 124C are included, two of the four driving/logic circuits are a group, and are respectively disposed on two opposite sides of the 2×2 low-side MOSFET array. Taking FIG. 7B as an example, the first driving/logic circuit 121C and the third driving/logic circuit 123C are arranged between the first high-side MOSFET and the third high-side MOSFET, and are respectively used for driving the turn-on and turn-off of the first IPM and the third IPM. The second driving/logic circuit 122C and the fourth driving/logic circuit 124C are disposed between the second high-side MOSFET and the fourth high-side MOSFET for driving the turn-on and turn-off of the second IPM and the fourth IPM, respectively.

FIG. 7C is another embodiment of an internal IPM placement in the substrate 110, different from the internal placement diagram shown in FIG. 6G in that the two driving/logic circuits 125C and 126C are respectively disposed on two opposite sides of the 2×2 low-side MOSFET array (i.e. no two sides of the high-side MOSFET are provided). The driving/logic circuit 125C is configured to drive the turn-on and turn-off of the first IPM and the second Dr. The driving/logic circuit 126C is configured to drive the turn-on and turn-off of the third IPM and the fourth IPM.

FIG. 7D is another embodiment of the internal placement in the substrate 110, a high-side MOSFET, a low-side MOSFET and a driving/logic circuit are a sub-unit. In each sub-unit, the high-side MOSFET and the driving/logic circuit are all arranged along the same side of the low-side MOSFET (i.e. arranged in a “2+1” manner); the four sub-units are arranged in the manner of a windmill blade; that is, after each subunit is rotated by a certain angle in a clockwise or counterclockwise direction, it can coincide with an adjacent subunit.

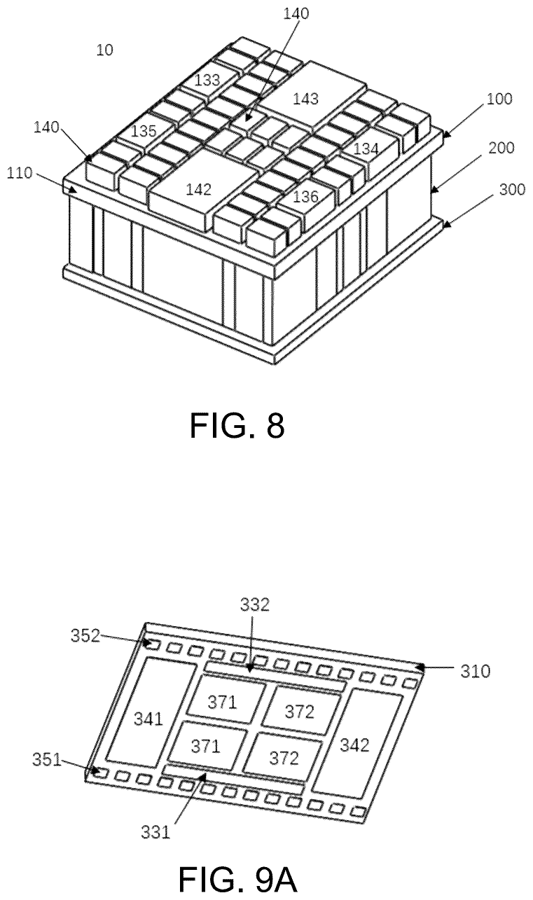

FIG. 8 is another embodiment of a top arrangement of the top assembly 100, the present embodiment differs from FIG. 7A in that the first heat dissipation copper blocks 133, 134, 135 and 136 and the second heat dissipation copper blocks 142 and 143 are included. The first heat dissipation copper blocks 133, 134, 135 and 136 are respectively used for heat dissipation of the first high-side MOSFET, the second high-side MOSFET, the third high-side MOSFET and the fourth high-side MOSFET, thereby reducing the upward thermal resistance of the power supply module; and the first heat dissipation copper blocks 133, 134, 135 and 136 are electrically connected to the drain electrodes of the first high-side MOSFET, the second high-side MOSFET, the third high-side MOSFET and the fourth high-side MOSFET, respectively, so as to reduce the direct-current impedance of the wiring layer on the top substrate 110. Therefore, the heat dissipation performance of the power supply module is improved by the first heat dissipation copper blocks, and the conversion efficiency of the power supply module is improved on the other hand. The second heat dissipation copper block 142 is used for heat dissipation of the first low-side MOSFET and the second low-side MOSFET, and the second heat dissipation copper block 142 is electrically connected to the source of the first low-side MOSFET and the second low-side MOSFET, thereby reducing the thermal resistance of the power supply module and reducing the direct-current impedance of the wiring layer on the bottom substrate, and improving the heat dissipation capability and conversion efficiency of the power supply module. The second heat dissipation copper block 143 is used for heat dissipation of the third low-side MOSFET and the fourth low-side MOSFET, and the second heat dissipation copper block 143 is electrically connected to the source of the third low-side MOSFET and the fourth low-side MOSFET, so that the same technical effect of the second heat dissipation copper block 142 can be obtained, which will not be repeated here. In addition, an input capacitor 140 is further provided between the second heat dissipation copper blocks 142 and 143, that is, the input capacitor 140 is provided at a central position symmetrical to the four low-side MOSFETs, and the arrangement of the input capacitors here facilitates mutual cancellation of the input ripple current of the four-phase voltage regulator module, thereby facilitating further improving the conversion efficiency of the power supply module.

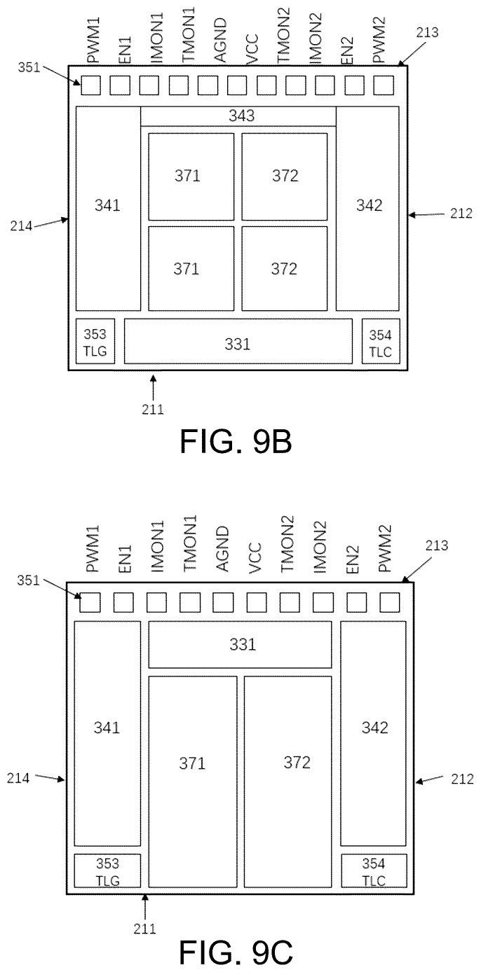

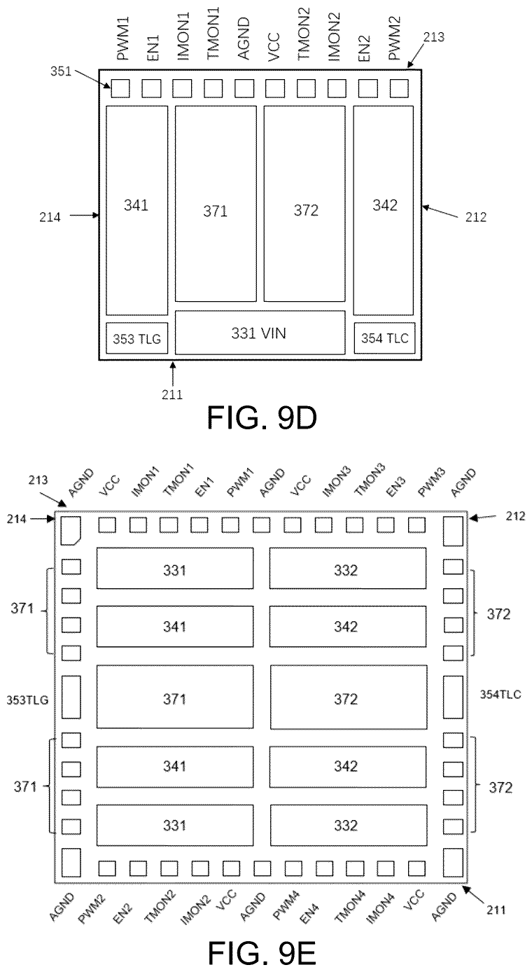

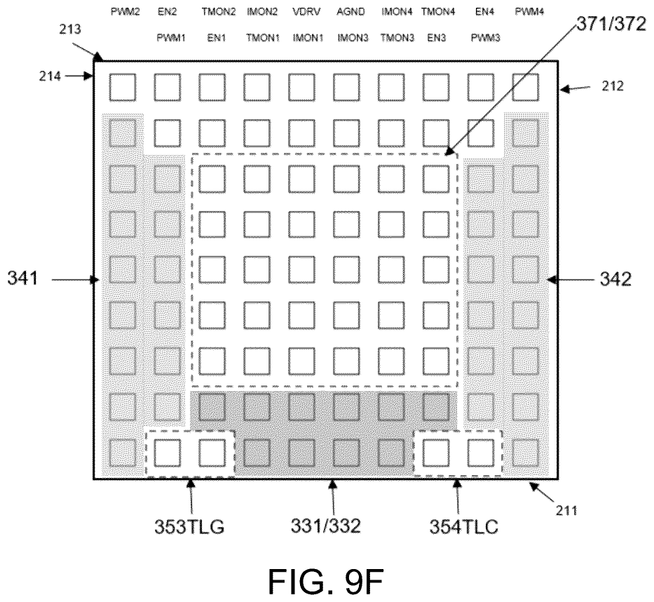

FIGS. 9A-9D are expanded embodiments of a top surface pin arrangement of the bottom assembly 300. As shown in FIG. 9A, the two output pins 371 and the two output pins 372 are arranged in a 2×2 array, the second power pins (i.e. GND pins) 341 and 342 are respectively arranged on two opposite sides of the output pin array, the first power pins 331 and 332 are arranged on two opposite sides of the output pin array, and the signal pins 351 and 352 are respectively arranged adjacent to the first power pins 331 and 332. In detail, the signal pin 351 is disposed adjacent to the first side surface 211 of the magnetic core, the signal pin 352 is disposed adjacent to the third side surface 213 of the magnetic core; the second power pin 341 is disposed adjacent to the fourth side surface 214 of the magnetic core, the second power pin 342 is disposed adjacent to the second side surface 212 of the magnetic core; the output pin 371 is disposed adjacent to the second power pin 341, and the output pin 372 is disposed adjacent to the second power pin 342. The pin arrangement diagram of the present embodiment has the same technical effect as the pin arrangement diagram shown in FIG. 6B.

FIG. 9B is another embodiment of a top surface pin arrangement diagram of the bottom assembly 300, and the two output pins 371 and the two output pins 372 are arranged in a 2×2 array; the second power pins 341 and 342, the second power pins 343 and the first power pins 331 are respectively arranged on four sides of the 2×2 output pin array, and the GND pins 341 and 342 are respectively arranged on two opposite sides of the 2×2 output pin array, and the GND pins 343 are electrically connected to the GND pins 341 and 342; the first power pin 331 is disposed adjacent to the first side surface 211 of the magnetic core, the GND pins 341 and 342 are disposed adjacent to the fourth side surface 214 and the second side surface 212 of the magnetic core, respectively, and the two output pins 371 are adjacent to the GND pin 341, the two output pins 372 are adjacent to the GND pin 342. The top surface of the bottom assembly 300 is further provided with a TLVR function extension TLG pin 353 and a function expansion TLC pin 354, the TLG pin 353 is disposed adjacent to the first side surface 211 and the fourth side surface 214 of the magnetic core, and the TLC pin 354 is disposed adjacent to the first side surface 211 and the second side surface 212 of the magnetic core; the signal pin 351 is disposed adjacent to the third side surface 213 of the magnetic core. In this embodiment, the pin arrangement can further optimize the power loop, thereby further improving the conversion efficiency of the power module.

FIG. 9C is another embodiment of a top surface pin arrangement diagram of the bottom assembly 300, different from the embodiment of FIG. 9B in that only one output pin 371 and one output pin 372 are included, the output pins 371 and 372 are both rectangular and both extending to the first side 211 of the magnetic core. The first power pin 331 is arranged adjacent to the third side surface 213 of the magnetic core; the second power pin 341 is disposed adjacent to the fourth side surface 214 and the output pin 371 of the magnetic core, the second power pin 342 is disposed adjacent to the second side surface 212 of the magnetic core and the output pin 372. Other technical features are the same as those shown in FIG. 9B, and will not be repeated here.

FIG. 9D is another embodiment of a top surface pin arrangement of the bottom assembly 300, different from the embodiment of FIG. 9C in that the output pins 371 and 372 extend to the third side surface 213 of the magnetic core; the first power pin 331 is disposed adjacent to the first side surface 211 of the magnetic core; other technical features are the same as those shown in FIG. 9C, and the same technical benefits can be obtained.

FIG. 9E is an embodiment of a bottom surface pin arrangement diagram of the bottom assembly 300, the output pin, the first power pin and the second power pin are divided into two columns, and each column is arranged according to the sequence of the first power pin 331/332, the second power pin 341/342, the output pin 371/372, the second power pin 341/342 and the first power pin 331/332, that is, the pins are arranged symmetrically along the horizontal axis and the vertical axis. In addition, the plurality of output pins 371 are divided into two groups which are arranged along the fourth side surface 214; and the plurality of output pins 372 are divided into two groups which are arranged along the second side surface 212. The function extension TLC pin 354 and the TLG pin 353 are disposed adjacent to the second side surface 212 and the fourth side surface 214 of the magnetic core, respectively, and the function extension TLC pin 354 is disposed between the two sets of output pins 372 of the second side surface 212, the function extension TLG pin 353 is disposed between the two sets of output pins 371 of the fourth side surface 214. A plurality of signal pins are disposed along the first side surface 211 and the third side surface 213.

FIG. 9F is another embodiment of a bottom surface pin arrangement diagram of the bottom assembly 300. The bottom surface pin adopts a pin array or a BGA array. In this embodiment, the pin array is adopted. The plurality of output pins 371 and 372 are arranged in an array of 5×6 pins and are arranged in a central area of the bottom surface of the bottom assembly 300; the plurality of second power pins 341 are arranged in two columns along the fourth side surface 214; the plurality of second power pins 342 are arranged in two columns along the second side surface 212; the plurality of first power pins 331 and 332 are arranged in two rows along the first side surface 211; the function extension TLC pin 354 and the TLG pin 353 are arranged adjacent to the first side surface 211, and the function expansion TLC pin 354 is arranged between the plurality of first power pins 331/332 and the plurality of second power pins 342, and the function expansion TLG pin 353 is arranged between the plurality of first power pins 331/332 and the plurality of first power pins 341; and the plurality of signal pins are arranged along the third side surface 213. The bottom surface pin of the bottom assembly 300 is used for being fixedly electrically connected to the external assembly, such that the uniform distribution of the input or output power on the bottom assembly can be reduced, the power transmission path and the area of the power loop can be reduced, the influence of interference is reduced, and the working reliability of the power supply module is further ensured.

FIGS. 7A-7D illustrate an expanded implementation of an internal arrangement of the substrate 110, an expanded implementation of a top layout of the top assembly shown in FIG. 8, FIGS. 9A-9D are extended embodiments of a top surface pin arrangement of the bottom assembly 300 and the embodiments of the bottom-surface pin arrangement of FIGS. 9E and 9F can be freely combined and applied to a power supply module, and can be applied to the foregoing embodiments to obtain the same technical benefits.

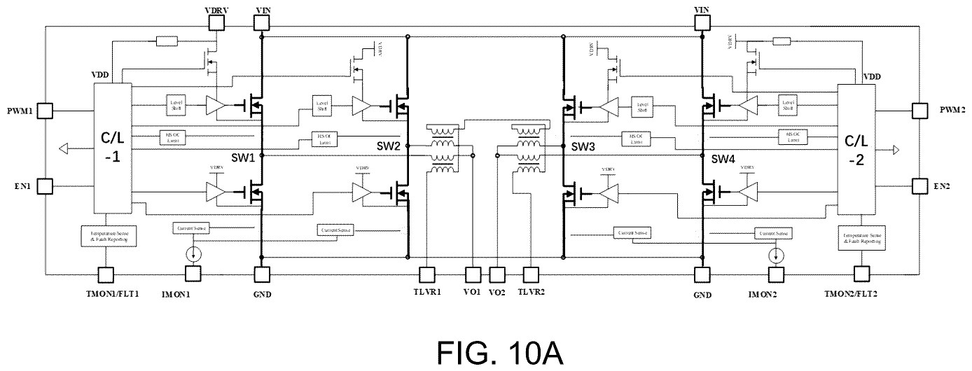

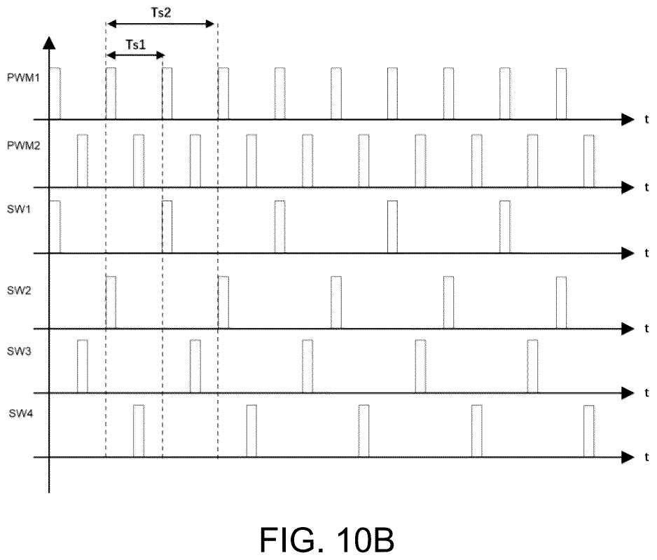

FIG. 10A provides a functional block diagram of a 4-phase VRM, in which PWM 1 and PWM2 are control signals from the external controller to control the turn-on and turn-off of the VRM; the period of the control signals PWM1 and PWM2 is Ts1, as shown in FIG. 10B; preferably, the control signals PWM1 and PWM2 are 180 degrees out of phase. The control signal PWM1 generates two driving signals by means of the expansion processing of the control logic circuit C/L-1, the period of the two driving signals is Ts2, and the phase shift is 180 degrees, and the period Ts2 is twice the period Ts1; the two drive signals respectively drive the two half-bridge circuits, a summed current detection signal Imon1 is generated by the current detection signals of the two half-bridge circuits by means of the control logic circuit C/L-1, the frequency and phase of the control signal PWM1 and the summed current detection signal Imon1 are the same, and the control signal PWM1 and the summed current detection signal Imon1 are respectively connected to the control signal pin and the current detection signal pin of the same phase of the multi-phase controller. The control signal PWM2 generates another two driving signals by means of the expansion processing of the control logic circuit C/L-2, the period of the other two driving signals is Ts2, and is also 180 degrees out of phase with each other; similarly, the other two drive signals respectively drive two half-bridge circuits, a summed current detection signal Imon2 are generated by the current detection signals of the two half-bridge circuits by means of the control logic circuit C/L-2, the frequency and phase of the control signal PWM2 and the summed current detection signal Imon2 are the same, and the control signal PWM2 and the summed current detection signal Imon2 are respectively connected to the control signal pin and the current detection signal pin of the same phase of the multi-phase controller. The four drive signals can respectively control the turn-on and turn-off of the 4-phase VRM. The four-phase VRM in the present application uses the control signals PWM1 and PWM2 with 180 degrees of phase shift to control the four-phase VRM to operate alternately with 90 degrees out of phase, so that the input/output current ripple can be reduced, and the number of input/output capacitors can be reduced. As shown in FIG. 10B, SW1, SW2, SW3, and SW4 respectively represent voltages of connection points SW of the four-phase Buck circuit, and SW1, SW3, SW2, and SW 4 are sequentially staggered by 90 degrees.

The control function shown in FIG. 10A and FIG. 10B is applicable to the four-phase VRM disclosed in the foregoing embodiments, but is not limited thereto, as long as four phases of Buck circuit connected in a parallel manner of input and output. The present application is described by taking 4-phase VRM as an example, but the present application is not limited to only use in the case of 4 phases, and the structure of the present application can be used for VRM of any phase. The copper columns or copper blocks disclosed in the present application are also not limited to copper materials, and can also be aluminum, copper-aluminum alloys, or other metals or metal alloys, as long as metal or metal alloys having good conductive and thermal conductivity characteristics can be used.

The MOSFET disclosed by the application can be used for realizing the functions of the switch disclosed by the application, such as a Si MOSFET, SiC MOSFET, GaN MOSFET or IGBT MOSFET.

The power supply module according to the embodiment can be an independent module or a part of the electronic device, and can meet the technical features and advantages disclosed by the application.

The “equal” or “same” or “equal to” disclosed by the application needs to consider the parameter distribution of engineering, and the error distribution is within +/−30%; and the included angle between the two line segments or the two straight lines is less than or equal to 45 degrees; the included angle between the two line segments or the two straight lines is within the range of [60, 120]; and the definition of the phase error phase also needs to consider the parameter distribution of the engineering, and the error distribution of the phase error degree is within +/−30%.

The embodiments in the specification are described in a progressive manner, each embodiment focuses on the difference from other embodiments, and the same similar parts between the embodiments can be referred to each other.

The above description of the disclosed embodiments enables a person skilled in the art to implement or use the present application. Various modifications to these embodiments will be readily apparent to those skilled in the art, and the generic principles defined herein may be implemented in other embodiments without departing from the spirit or scope of the application. Thus, the present application will not be limited to the embodiments shown herein but is to be accorded the widest scope consistent with the principles and novel features disclosed herein.

What is claimed is:

1. A voltage regulator module, comprising a top assembly and a middle assembly; the top assembly comprises a top substrate, N intelligent power modules and metal blocks, N being a natural number greater than 1; the top substrate comprises a top surface and a bottom surface opposite to each other, the intelligent power modules are disposed on the bottom surface of the top substrate or embedded in the top substrate, and the metal blocks are disposed on the top surface of the top substrate; the intelligent power module comprises a top surface and a bottom surface opposite to each other, and the top surface of the intelligent power module is electrically connected to the top substrate; the middle assembly is disposed adjacent to the bottom surface of the top substrate and is electrically connected to the intelligent power module.

2. The voltage regulator module of claim 1, wherein the middle assembly comprises a top surface and a bottom surface opposite to each other, a magnetic core, a winding and an electrical connector, the magnetic core comprises a first side surface and a third side surface opposite to each other, a second side surface and a fourth side surface opposite to each other, and a top surface and a bottom surface opposite to each other, a first end of the winding is electrically connected to the bottom surface of the intelligent power module, the electrical connector is disposed on the side surface of the magnetic core, and the electrical connector is electrically connected to the metal block by means of the top substrate.

3. The voltage regulator module of claim 2, wherein the electrical connector comprises a first power electrical connector and a second power electrical connector, the metal block comprises a first metal block and a second metal block, the first power electrical connector is electrically connected to the first metal block, and the second power electrical connector is electrically connected to the second metal block.

4. The voltage regulator module of claim 2, wherein the intelligent power module comprises a high-side power switch and a low-side power switch, the high-side power switch and the low-side power switch are both vertical power switches, and the high-side power switch and the low-side power switch are electrically connected in series.

5. The voltage regulator module of claim 4, wherein a drain of the high-side power switch and a source of the low-side power switch are both disposed on a top surface of the vertical switch, a source of the high-side power switch and a drain of the low-side power switch are both disposed on a bottom surface of the vertical switch, and the source of the high-side power switch and the drain of the low-side power switch are electrically connected in series to the SW terminal.

6. The voltage regulator module of claim 5, wherein the electrical connector comprises a first power electrical connector and a second power electrical connector, the drain of the high-side power switch is electrically connected to the first power electrical connector, the source of the low-side power switch is electrically connected to the second power electrical connector, and the first end of the winding is electrically connected to the SW terminal.

7. The voltage regulator module of claim 2, further comprising a bottom assembly, wherein the bottom assembly comprises a bottom substrate, the bottom substrate comprises a top surface and a bottom surface opposite to each other and a pin, a second end of the winding and the electrical connector are both electrically connected to the pin of a top surface of the bottom substrate, and the bottom surface of the bottom substrate is electrically connected to an external load.

8. The voltage regulator module of claim 3, wherein the middle assembly further comprises a signal electrical connector, the signal electrical connector is electrically connected to the intelligent power module, and the signal electrical connector is disposed on the side surface of the magnetic core.

9. The voltage regulator module of claim 3, wherein the first power electrical connector is disposed on the first side surface and the third side surface of the magnetic core, and the second power electrical connector is disposed on the second side surface and the fourth side surface of the magnetic core.

10. The voltage regulator module of claim 3, wherein the first power electrical connector and the second power electrical connector are both disposed on the second side surface and the fourth side surface of the magnetic core, and the first power electrical connector is located on two sides of the second power electrical connector.

11. The voltage regulator module of claim 3, wherein the metal block comprises at least two first metal blocks and at least one second metal block, the second metal block is arranged between the first metal blocks, the top assembly further comprises an input capacitor, the input capacitor is arranged between the first metal block and the second metal block, the first metal block, the second metal block and the input capacitor are sequentially arranged according to the order of the first metal block, the input capacitor, the second metal block, the input capacitor and the first metal block.

12. The voltage regulator module of claim 1, wherein the bottom surface of the top assembly is provided with a pin, the pin comprises an input pin VIN, a ground pin GND, and a switch middle pin SW, the metal block comprises a first metal block and a second metal block, the electrical connector comprises a first power electrical connector and a second power electrical connector, the input pin VIN is electrically connected to the first metal block and the first power electrical connector, the ground pin GND is electrically connected to the second metal block and the second power electrical connector, and the switch middle pin SW is electrically connected to the bottom surface of the intelligent power module.

13. The voltage regulator module of claim 12, wherein the top assembly further comprises a metal column disposed on the bottom surface of the top substrate, the intelligent power module and the metal column are molded together by a plastic packaging material, the metal column is electrically connected to the metal block by means of the top substrate, the pin is provided on a surface of the plastic packaging material, and the pin is electrically connected to the winding and the electrical connector.

14. The voltage regulator module of claim 12, wherein the pin is arranged on the bottom surface of the top substrate, and the pin of the bottom surface of the top substrate is electrically connected to the metal block and the intelligent power module by means of a wiring or a metal column.

15. The voltage regulator module of claim 12, wherein the pin of the bottom surface of the top assembly further comprises a signal pin, the middle assembly further comprises a signal electrical connector, and the signal pin is electrically connected to the signal electrical connector and the intelligent power module.

16. The voltage regulator module of claim 15, wherein the signal electrical connector is a vertical plate structure.

17. The voltage regulator module of claim 15, wherein the signal pin is realized by drilling and electroplating.

18. The voltage regulator module of claim 5, wherein the N intelligent power modules are arranged in an array, wherein the low-side power switch of the N intelligent power modules are disposed adjacent to each other, the high-side power switch of each intelligent power module is disposed adjacent to the corresponding low-side power switch, and the switches of the intelligent power modules located in the same row are arranged in a sequence of the high-side power switch, the low-side power switch, the low-side power switch, and the high-side power switch.

19. The voltage regulator module of claim 18, wherein the intelligent power module further comprises a driving/logic circuit, and the driving/logic circuit and the high-side power switch are arranged in parallel and are all arranged on the same outer side of the low-side power switch.

20. The voltage regulator module of claim 2, wherein the winding comprises a main winding and an auxiliary winding, the electrical connector comprises a first power electrical connector, a second power electrical connector and an auxiliary winding electrical connector, the main winding and the auxiliary winding are coupled to each other, the first power electrical connector and the second power electrical connector are electrically connected to the top surface of the intelligent power module by means of the top substrate, and the bottom surface of the intelligent power module is electrically connected to the main winding.

21. The voltage regulator module of claim 20, wherein the first power electrical connector is disposed on the first side surface and the third side surface of the magnetic core, the second power electrical connector and the auxiliary winding electrical connector are both disposed on the second side surface and the fourth side surface of the magnetic core, and the auxiliary winding electrical connector and the second power electrical connector are alternately disposed.

22. The voltage regulator module of claim 20, further comprising a bottom assembly, wherein the bottom assembly comprises a bottom substrate, the bottom substrate comprises a top surface and a bottom surface opposite to each other and a pin, wherein the pin is disposed on the top surface and the bottom surface of the substrate; the first power electrical connector, the second power electrical connector, the main winding and the auxiliary winding electrical connector are all electrically connected to the pin of the top surface of the bottom substrate, and the auxiliary winding is connected in series by means of the auxiliary winding electrical connector, the top substrate and the bottom substrate to form an auxiliary winding loop, and the bottom surface of the bottom component is electrically connected to an external load.

23. The voltage regulator module of claim 22, wherein the pin of the top surface of the bottom substrate comprises a first power pin, a second power pin and an output pin, the output pin is located in the middle of the bottom substrate or adjacent to the first side surface of the magnetic core, the first power pin and the second power pin surround the periphery or three side edges of the output pin, the first power pin is disposed adjacent to the first side surface and/or the third side surface of the magnetic core, the second power pin is disposed adjacent to the second side surface and the fourth side surface of the magnetic core, and the first power pin is disposed adjacent to the second power pin.

24. The voltage regulator module of claim 23, wherein the output pin comprises two first output pins and two second output pins, the four output pins are arranged in a 2*2 array, the two first output pins are arranged close to the second side surface of the magnetic core, and the two second output pins are arranged close to the fourth side surface of the magnetic core.

25. The voltage regulator module of claim 23, wherein there are three second power pins sequentially disposed on three side edges of the output pin, the first power pin is disposed on the fourth side edge of the output pin, and the three second power pins are electrically connected in sequence.

26. The voltage regulator module of claim 23, wherein the output pin comprises a first output pin and a second output pin, and both output pins are in rectangular shape.

27. The voltage regulator module of claim 23, wherein the pin of the top surface of the bottom substrate comprises a signal pin, and the signal pin is disposed adjacent to the first side surface and/or the third side surface of the magnetic core.

28. The voltage regulator module of claim 23, wherein the pin of the top surface of the bottom substrate comprises a TLG extension pin and a TLC extension pin, and the TLG extension pin and the TLC extension pin are respectively arranged adjacent to a corner of the first side surface close to the second side surface of the magnetic core and a corner of the first side surface close to the fourth side surface of the magnetic core.

29. The voltage regulator module of claim 22, wherein the pin of the bottom surface of the bottom substrate comprises an output pin, a first power pin and a second power pin, the output pin is arranged in the middle of the bottom surface of the bottom substrate, the first power pin and the second power pin are arranged around the output pin, and the first power pin and the second power pin are arranged adjacent to each other.

30. The voltage regulator module of claim 29, wherein the pin of the bottom surface of the bottom substrate further comprises a signal pin, and the signal pin is disposed adjacent to the first side surface and/or the third side surface of the magnetic core and located outside the first power pin.

31. The voltage regulator module of claim 29, wherein the pin of the bottom surface of the bottom substrate further comprises a TLG expansion pin and a TLC expansion pin, and the TLG extension pin and the TLC extension pin are provided at positions of two or four corners of the bottom surface of the substrate.

32. The voltage regulator module of claim 22, wherein the pin of the bottom surface of the bottom substrate comprises an output pin, a first power pin and a second power pin, the output pin, the first power pin and the second power pin are sequentially arranged in the same direction as the sequence of the first power pin, the output pin, the second power pin, the output pin and the first power pin, the pin of the bottom substrate further comprises a signal pin, the signal pin is arranged adjacent to the first side surface and/or the third side surface of the magnetic core, and part of the signal pin is a TLG extension pin and a TLC extension pin.

33. The voltage regulator module of claim 22, wherein the pin of the bottom surface of the bottom substrate is m*n LGA pins, where m and n are both integers greater than or equal to 1.

34. The voltage regulator module of claim 22, wherein the pins of the bottom surface of the bottom substrate comprise a first power pin, a second power pin and an output pin, the first power pin, the second power pin, and the output pin are divided into two columns, and each column is arranged according to the sequence of the first power pin, the second power pin, the output pin, the second power pin, and the first power pin; a signal pin, a TLG extension pin, a TLC expansion pin and an auxiliary output pin are also arranged around the two columns of pins, the auxiliary output pin is respectively arranged adjacent to the second side surface and the fourth side surface of the magnetic core, the TLG extension pin is arranged between the auxiliary output pins adjacent to the second side surface the TLC extension pin is arranged between the auxiliary output pins adjacent to the fourth side edge, and the signal pins are arranged on the first side surface and the third side surface of the magnetic core.

35. The voltage regulator module of claim 22, wherein the pin of the bottom surface of the bottom substrate adopts a pin array or a BGA array, the pin of the bottom surface of the bottom substrate includes an output pin, a first power pin, a second power pin, a signal pin, a TLG extension pin and a TLC extension pin, the output pin is arranged in an array of m*n pins, m and n are natural numbers greater than 1, and are located in a central region of the bottom substrate, the second power pin is arranged in two columns along the second side surface and the fourth side surface of the magnetic core respectively, the first power pin is arranged in two rows along the first side surface of the magnetic core, the TLG extension pin and the TLC extension pin are arranged adjacent to the first side surface of the magnetic core and are respectively located between the first power pin and the second power pin, and the signal pin is arranged along the third side surface of the magnetic core.

36. The voltage regulator module of claim 2, wherein the bottom surface of the top substrate is provided with other passive elements, the top surface of the magnetic core is provided with a groove, and the groove is used for accommodating the other passive elements.

37. The voltage regulator module of claim 4, wherein the top assembly further comprises a driving/logic circuit, one driving/logic circuit simultaneously controls two intelligent power modules, the driving/logic circuit is disposed between the two intelligent power modules, or the driving/logic circuit is disposed on a same side of two low-side power switches of the two intelligent power modules, the low-side power switches of the adjacent intelligent power modules are disposed adjacent to each other, and the high-side power switch is disposed on an outer side of the low-side power switch.

38. The voltage regulator module of claim 4, further comprising N driving/logic circuits, each driving/logic circuit, each high-side power switch and each low-side power switch form a sub-unit, the driving/logic circuit and the high-side power switch are arranged side by side on one side of the low-side power switch, and the low-side power switches of the N sub-units are arranged adjacent to each other.

39. The voltage regulator module of claim 4, further comprising N driving/logic circuits, each driving/logic circuit, each high-side power switch and each low-side power switch form a sub-unit, the driving/logic circuit and the high-side power switch are arranged side by side on one side of the low-side power switch, each of the sub-units coincides with its adjacent sub-unit by rotating clockwise or counterclockwise by a certain angle.

40. The voltage regulator module of claim 21, wherein the bottom surface of the top substrate is provided with an input pin VIN, a ground pin GND, a switch middle pin SW, an auxiliary winding pin and an auxiliary winding electrical connector pin, the position of the switch middle pin SW is in one-to-one correspondence with the position of the main winding of the middle assembly and the switch middle pin SW is electrically connected with the main winding; the position of the auxiliary winding pin is in one-to-one correspondence with the position of the auxiliary winding and the auxiliary winding pin is electrically connected with the auxiliary winding; the position of the auxiliary winding electrical connector pin is in one-to-one correspondence with the position of the auxiliary winding electrical connector and the auxiliary winding electrical connector pin is electrically connected with the auxiliary winding electrical connector; the position of the input pin VIN is in one-to-one correspondence with the position of the first power electrical connector and the input pin is electrically connected with the first power electrical connector; and the position of the ground pin GND is in one-to-one correspondence with the position of the second power electrical connector and the ground pin GND is electrically connected with the second power electrical connector.

41. The voltage regulator module of claim 40, wherein the bottom surface of the top substrate is further provided with a first signal pin and a second signal pin, the electrical connector further comprises a first signal electrical connector and a second signal electrical connector; the positions of the first signal pin and the first signal electrical connector are in one-to-one correspondence and the first signal pin is electrically connected to the first signal electrical connector; the positions of the second signal pin and the second signal electrical connector are in one-to-one correspondence and the second signal pin is electrically connected to the second signal electrical connector.

42. The voltage regulator module of claim 41, wherein the first signal electrical connector is a vertical plate structure and is disposed adjacent to on the third side surface of the magnetic core, the second signal electrical connector is disposed adjacent to the first side surface and the third side surface of the magnetic core, respectively, and the second signal electrical connector is electronically connected to a TLG expansion pin and a TLC expansion pin.

43. The voltage regulator module of claim 4, wherein the metal block comprises a plurality of first metal blocks and a plurality of second metal blocks, each of the first metal blocks is electrically connected to the drain of one high-side power switch respectively, and each of the second metal blocks is electrically connected to the source of two adjacent low-side power switches, respectively.

44. The voltage regulator module of claim 43, the N low-side power switches are disposed adjacent to each other, and the top assembly further comprises input capacitor, the input capacitor is arranged among the second metal blocks and the central position of the N low-side power switches.

45. The voltage regulator module of claim 1, wherein in the top substrate or on the bottom surface of the top substrate is provided with a high-frequency capacitor, and the high-frequency capacitor is disposed adjacent to the intelligent power module.

46. The voltage regulator module of claim 3, wherein the high-efficiency power supply module comprises an input positive terminal, an input negative terminal, an output positive terminal and an output negative terminal, and the input negative terminal and the output negative terminal are short-circuited to the GND terminal; the first metal block is electrically connected to the positive terminal, and the second metal block is electrically connected to the GND terminal.

47. A 4-phase VRM control method, comprising four Buck circuits; and the four Buck circuits are electrically connected in parallel; further comprising a first control signal PWM1, a second control signal PWM2, a first current detection signal, a second current detection signal, a first control logic circuit, a second control logic circuit, and a multiphase controller; the first control signal PWM1 and the second control signal PWM2 have the same period and are 180° out of phase; two drive signals are generated by the first control signal PWM1 by means of the first control logic circuit, the periods of the two drive signals are both twice the period of the first control signal PWM1, the two drive signals respectively drives two Buck circuits; a first summed current detection signal is generated by the first current detection signal by means of a first control logic circuit; the frequency and phase of the first summed current detection signal are the same as the first control signal PWM1, and the first control signal PWM1 and the first summed current detection signal are respectively connected to a control signal pin and a current detection signal pin of the same phase of the multiphase controller; two drive signals are generated by the second control signal PWM2 by means of the second control logic circuit, the two drive signals respectively drive the other two Buck circuits, the period of the two drive signals is twice the second control signal PWM2; a second summed current detection signal is generated by the second current detection signal by means of the second control logic circuit, the frequency and phase of the second summed current detection signal are the same as the second control signal PWM2, and the second control signal PWM2 and the second summed current detection signal are respectively connected to the control signal pin and the current detection signal pin of the same phase of the multiphase controller.

48. A voltage regulator module, comprising a top assembly and a middle assembly, wherein the top assembly comprises a top substrate, an input positive pin, a ground pin and an intelligent power module, the middle assembly comprises a magnetic core, a winding and an electrical connector; the intelligent power module is arranged on a bottom surface of the top substrate or embedded in the top substrate, the input positive pin and the ground pin are arranged on the top surface of the top substrate, a top surface of the intelligent power module is electrically connected to the input positive pin and the ground pin by means of the top substrate, a bottom surface of the intelligent power module is electrically connected to a first end of the winding, a second end of the winding is electrically connected to an external load, the first end of the winding is arranged on the top surface of the middle assembly, and the second end of the winding is arranged on the bottom surface of the middle assembly; the electrical connector includes a power electrical connector disposed on a side surface of the magnetic core, and the power electrical connector is electrically connected to the ground pin.

49. The voltage regulator module of claim 48, wherein the top assembly further comprises multiple metal blocks disposed on the top surface of the top substrate and the metal blocks are electrically connected to the input positive pin and the ground pin respectively.

50. The voltage regulator module of claim 49, wherein the top assembly further comprises an input capacitor, and the input capacitor is connected across the input positive pin and the ground pin.

51. The voltage regulator module of claim 48, wherein the intelligent power module comprises a high-side power switch and a low-side power switch, the high-side power switch and the low-side power switch are both vertical switches, the drain of the high-side power switch and the source of the low-side power switch are disposed on the top surface of the vertical switch, the source of the high-side power switch and the drain of the low-side power switch are disposed on the bottom surface of the vertical switch and are shorted to the switch middle end SW, the drain of the high-side power switch is disposed adjacent to the input positive pin and is electrically connected to the input positive pin, the source of the low-side power switch is disposed adjacent to the ground pin and is electrically connected to the ground pin, and the switch middle end SW is disposed adjacent to the winding and is electrically connected to the first end of the winding.

52. The voltage regulator module of claim 51, further comprising a bottom assembly; a bottom surface of the bottom assembly is provided with an output pin and a power pin; the output pin is electrically connected to the second end of the winding; the power pin is electrically connected to the power electrical connector; and the output pin and the power pin form an output terminal of the voltage regulator module.

53. An intelligent power module arrangement, wherein the intelligent power module layout comprises a plurality of intelligent power modules, and each intelligent power module comprises a high-side power switch and a low-side power switch; the high-side power switch and the low-side power switch are electrically connected in series; the plurality of low-side power switches are arranged adjacent to each other; the plurality of high-side power switches are arranged at the periphery of the plurality of low-side power switches and are respectively arranged adjacent to the corresponding low-side power switches; the plurality of intelligent power modules are arranged symmetrically along a symmetric axis, or in a windmill shape.

54. The intelligent power module arrangement of claim 53, wherein both the high-side power switch and the low-side power switch are vertical power switches, the drain of the high-side power switch and the source of the low-side power switch are both disposed on a top surface of the vertical switch, the source of the high-side power switch and the drain of the low-side power switch are both disposed on a bottom surface of the vertical switch, and the source of the high-side power switch and the drain of the low-side power switch are electrically connected in series to a SW terminal.

55. The intelligent power module arrangement of claim 52, wherein the switches in the intelligent power module of the same row are arranged in a sequence of a high-side power switch, a low-side power switch, a low-side power switch, and a high-side power switch.

56. The intelligent power module arrangement of claim 52, wherein each of the intelligent power modules further comprises a driving/logic circuit, and the driving/logic circuit and the high-side power switch are arranged side by side and are both arranged on the same outer side of the low-side power switch.

57. The intelligent power module arrangement of claim 53, further comprising at least one driving/logic circuit, wherein one driving/logic circuit simultaneously controls two intelligent power modules, the driving/logic circuit is disposed between two intelligent power modules, or the driving/logic circuit is disposed on the same side of two low-side power switches of the two intelligent power modules.

58. The intelligent power module arrangement of claim 53, wherein each of the intelligent power modules further comprises a driving/logic circuit, the driving/logic circuit and the high-side power switch are arranged side by side on one side of the low-side power switch, and each intelligent power module coincides with its adjacent intelligent power module after rotating clockwise or counterclockwise by a certain angle.

59. A pin arrangement of a voltage regulator module, wherein the voltage regulator module comprises an intelligent power module and a middle assembly; the voltage regulator module further comprises a top surface and a bottom surface opposite to each other, a first side surface and a third side surface opposite to each other, and a second side surface and a fourth side surface opposite to each other; the middle assembly comprises a magnetic core and a winding; the intelligent power module is electrically connected to one end of the winding; the pins are arranged on the bottom surface of the voltage regulator module; the pin comprises an output pin, a first power pin and a second power pin; the output pin is arranged in the middle of the bottom surface of the voltage regulator module, and the first power pin and the second power pin are arranged around the output pin; the output pin is electrically connected to the other end of the winding, and the first power pin and the second power pin are electrically connected to the intelligent power module.

60. The pin arrangement of claim 59, wherein the first power pin is disposed adjacent to the first side surface and/or the third side surface of the voltage regulator module; the second power pin is disposed adjacent to the second side surface and/or the fourth side surface of the voltage regulator module; and further comprises a signal pin disposed on the first side surface and/or the third side surface of the voltage regulator module and located outside the first power pin.

61. The pin arrangement of claim 59, further comprising a TLG expansion pin and a TLC extension pin, wherein the TLG extension pin and the TLC extension pin are arranged at positions close to two or four corners of the bottom surface of the voltage regulator module.

62. The pin arrangement of claim 59, wherein the first power pin, the second power pin, and the output pin are arranged in two columns, each column is arranged according to a sequence of the first power pin, the second power pin, the output pin, the second power pin and the first power pin; a signal pin, a TLG extension pin, a TLC expansion pin and an auxiliary output pin are further arranged around the two columns of pins, the auxiliary output pin is respectively arranged on the second side surface and the fourth side surface of the voltage regulator module, the TLG extension pin is arranged between the auxiliary output pins located on the second side surface, the TLC extension pin is arranged between the auxiliary output pins located on the fourth side surface, and the signal pins are arranged on the first side surface and the third side surface.

63. The pin arrangement of claim 59, wherein the pins are arranged in a pin array or a BGA array, the output pins are arranged in an array of m*n pins, and m and n are natural numbers greater than 1; the second power pin is arranged in two columns along the second side surface and the fourth side surface, and the first power pin is arranged in two rows along the first side surface; the pin further comprises a signal pin, a TLG extension pin and a TLC extension pin; the TLG extension pin and the TLC extension pin are arranged adjacent to the first side surface and are respectively located between the first power pin and the second power pin, and the signal pin is arranged along the third side surface.
